(19) United States
(12) Patent Application Publication
(10) Pub. No.: US 2019/0119150 A1
(43) Pub. Date: Apr. 25, 2019

(54) METHODS FOR LASER PROCESSING TRANSPARENT WORKPIECES USING PULSED LASER BEAM FOCAL LINES AND CHEMICAL ETCHING SOLUTIONS

(71) Applicant: CORNING INCORPORATED, Corning, NY (US)

(72) Inventors: Robert Carl Burket, Elkland, PA (US); Daniel Wayne Levesque, JR., Avoca, NY (US); Sasha Marjanovic, Painted Post, NY (US); Garrett Andrew Piech, Corning, NY (US); Heather Nicole Vanselous, Painted Post, NY (US); Kristopher Allen Wieland, Painted Pos, NY (US)

(21) Appl. No.: 16/162,644

(22) Filed: Oct. 17, 2018

Related U.S. Application Data
(60) Provisional application No. 62/575,049, filed on Oct. 20, 2017.
(60) Provisional application No. 62/686,957, filed on Jun. 19, 2018.

(51) Int. Cl. C03C 15/00; C03C 23/00

(52) U.S. Cl. CPC C03C 15/00; C03C 23/0025

(57) ABSTRACT

A method for processing a transparent workpiece includes forming a closed contour line having a plurality of defects in the transparent workpiece such that the closed contour line defines a closed contour. Forming the closed contour line includes directing a pulsed laser beam through an aspheric optical element and into the transparent workpiece such that a portion of the pulsed laser beam directed into the transparent workpiece generates an induced absorption within the transparent workpiece, the induced absorption producing a defect within the transparent workpiece, and translating the transparent workpiece and the pulsed laser beam relative to each other along the closed contour line. The method further includes etching the transparent workpiece with a chemical etching solution at an etching rate of about 2.5 μm/min or less to separate a portion of the transparent workpiece along the closed contour line, thereby forming an aperture extending through the transparent workpiece, the aperture comprising an aperture perimeter extending along the closed contour.

The present application claims the benefit of priority under 35 U.S.C. § 119 to U.S. Provisional Patent Application No. 62/575,049 filed on Oct. 20, 2017, and the benefit of priority to U.S. Provisional Patent Application No. 62/686,957 filed on Jun. 19, 2018, the contents of which are relied upon and incorporated herein by reference in its entirety.

### BACKGROUND

### Field

The present specification generally relates to apparatuses and methods for laser processing transparent workpieces, and more particularly, to forming closed contour lines in transparent workpieces for forming apertures in transparent workpieces.

### Technical Background

The area of laser processing of materials encompasses a wide variety of applications that involve cutting, drilling, milling, welding, melting, etc. of different types of materials. Among these processes, one that is of particular interest is cutting or separating different types of transparent substrates in a process that may be utilized in the production of materials such as glass, sapphire, or fused silica for thin film transistors (TFT) or display materials for electronic devices.

From process development and cost perspectives there are many opportunities for improvement in cutting and separating glass substrates. It is of great interest to have a faster, cleaner, cheaper, more repeatable, and more reliable method of separating glass substrates than what is currently practiced in the market. Accordingly, a need exists for alternative improved methods for separating glass substrates.

### SUMMARY

According to some embodiments, a method for processing a transparent workpiece includes forming a closed contour line in the transparent workpiece, the closed contour line having a plurality of defects in the transparent workpiece such that the closed contour line defines a closed contour. Forming the closed contour line includes directing a pulsed laser beam oriented along a beam pathway and output by a beam source through an aspheric optical element and into the transparent workpiece such that a portion of the pulsed laser beam directed into the transparent workpiece generates an induced absorption within the transparent workpiece, the induced absorption producing a defect within the transparent workpiece, and the portion of the pulsed laser beam directed into the transparent workpiece includes a wavelength λ, a spot size w₀, and a cross section that comprises a Rayleigh range Z_{R} that is greater than

$${F}_{D} \frac{π {w}_{0 ,}^{2}}{λ} ,$$

where F_{D} is a dimensionless divergence factor comprising a value of 10 or greater. Forming the closed contour line also includes translating the transparent workpiece and the pulsed laser beam relative to each other along the closed contour line, thereby laser forming the plurality of defects along the closed contour line within the transparent workpiece. Further, the method for processing the transparent workpiece includes etching the transparent workpiece with a chemical etching solution at an etching rate of about 10 μm/min or less to separate a portion of the transparent workpiece along the closed contour line, thereby forming an aperture extending through the transparent workpiece, the aperture comprising an aperture perimeter extending along the closed contour.

In some embodiments, for the method of any of the preceding embodiments, the etching rate is about 5 μm/min or less.

In some embodiments, for the method of any of the preceding embodiments, the etching rate is about 2.5 μm/min or less.

In some embodiments, for the method of any of the preceding embodiments, the etching rate is about 1 μm/min or less.

In some embodiments, for the method of any of the preceding embodiments, etching the transparent workpiece removes about 50% or less of a thickness of the transparent workpiece.

In some embodiments, for the method of any of the preceding embodiments, etching the transparent workpiece removes about 25% or less of a thickness of the transparent workpiece.

In some embodiments, for the method of any of the preceding embodiments, etching the transparent workpiece removes about 15% or less of a thickness of the transparent workpiece.

In some embodiments, for the method of any of the preceding embodiments, etching the transparent workpiece removes about 10% or less of a thickness of the transparent workpiece.

In some embodiments, for the method of any of the preceding embodiments, etching the transparent workpiece removes about 7.5% or less of a thickness of the transparent workpiece.

In some embodiments, for the method of any of the preceding embodiments, a spacing between adjacent defects is about 50 μm or less.

In some embodiments, for the method of any of the preceding embodiments, a spacing between adjacent defects is about 25 μm or less.

In some embodiments, for the method of any of the preceding embodiments, a spacing between adjacent defects is about 15 μm or less.

In some embodiments, for the method of any of the preceding embodiments, a spacing between adjacent defects is about 10 μm or less.

In some embodiments, for the method of any of the preceding embodiments, a spacing between adjacent defects is about 5 μm or less.

In some embodiments, for the method of any of the preceding embodiments, the transparent workpiece comprises an alkali aluminosilicate glass material.

In some embodiments, for the method of any of the preceding embodiments, the aperture perimeter comprises a diameter of from about 100 μm to about 10 mm.

In some embodiments, for the method of any of the preceding embodiments, the aperture perimeter comprises a diameter of about 3 mm or less.

In some embodiments, for the method of any of the preceding embodiments, the aperture perimeter comprises a diameter of about 800 μm or less.

In some embodiments, for the method of any of the preceding embodiments, the chemical etching solution comprises a chemical etchant and deionized water.

In some embodiments, for the method of any of the preceding embodiments, the chemical etchant of the chemical etching solution comprises hydrofluoric acid, nitric acid, hydrochloric acid, sulfuric acid, or combinations thereof.

In some embodiments, for the method of any of the preceding embodiments, the chemical etching solution comprises a chemical etchant and deionized water and the chemical etchant of the chemical etching solution comprises sodium hydroxide or potassium hydroxide.

In some embodiments, for the method of any of the preceding embodiments, the chemical etching solution comprises from about 5M to 20M Sodium Hydroxide or 5M to 20M Potassium Hydroxide.

In some embodiments, for the method of any of the preceding embodiments, the chemical etching solution is maintained at a temperature between 70° C. to about 100° C.

In some embodiments, for the method of any of the preceding embodiments, the chemical etching solution further comprises a surfactant.

In some embodiments, for the method of any of the preceding embodiments, the chemical etching solution comprises from about 0.725M to about 2.9M hydrofluoric acid and from about 0.395M to about 2.37M nitric acid.

In some embodiments, for the method of any of the preceding embodiments, the chemical etching solution comprises from about 0.725M to about 1.45M hydrofluoric acid and from about 0.395M to about 0.79M nitric acid.

In some embodiments, for the method of any of the preceding embodiments, etching the transparent workpiece with the chemical etching solution comprises immersing the transparent workpiece in a chemical etching bath comprising the chemical etching solution.

In some embodiments, for the method of any of the preceding embodiments, the resulting contour has a ratio of top diameter to waist diameter of about 1:0.9 to about 1:0.99.

In some embodiments, for the method of any of the preceding embodiments, etching the transparent workpiece with the chemical etching solution comprises spraying the transparent workpiece from either side while on a horizontal roller system.

In some embodiments, for the method of any of the preceding embodiments, the resulting contour has a ratio of top diameter to waist diameter of about less than 1:0.9.

In some embodiments, for the method of any of the preceding embodiments, the resulting contour has a ratio of top diameter to waist diameter of about 1:0.95 to about 1:1.

In some embodiments, for the method of any of the preceding embodiments, the transparent workpiece is immersed in the chemical etching bath for an etching time of 1,000 mins or greater.

In some embodiments, for the method of any of the preceding embodiments, the transparent workpiece is immersed in the chemical etching bath for an etching time of from about 60 mins to about 200 mins.

In some embodiments, for the method of any of the preceding embodiments, the transparent workpiece is immersed in the chemical etching bath for an etching time of from about 15 mins to about 30 mins.

In some embodiments, for the method of any of the preceding embodiments, the temperature of the chemical etching solution when the transparent workpiece is immersed in the chemical etching bath is from about 0° C. to about 40° C.

In some embodiments, for the method of any of the preceding embodiments, the temperature of the chemical etching solution when the transparent workpiece is immersed in the chemical etching bath is about 20° C. or less.

In some embodiments, for the method of any of the preceding embodiments, the temperature of the chemical etching solution when the transparent workpiece is immersed in the chemical etching bath is about 10° C. or less.

In some embodiments, for the method of any of the preceding embodiments, the chemical etching bath comprises about 8 L to about 10 L of the chemical etching solution.

In some embodiments, for the method of any of the preceding embodiments, etching the transparent workpiece with the chemical etching solution further comprises agitating the chemical etching solution when the transparent workpiece is immersed in the chemical etching bath by means of fluid recirculation.

In some embodiments, for the method of any of the preceding embodiments, etching the transparent workpiece with the chemical etching solution further comprises agitating the chemical etching solution when the transparent workpiece is immersed in the chemical etching bath by means of ultrasonic energy of frequencies 40 kHz, 58 kHz, 80 kHz, 120 kHz, 132 kHz, 192 kHz or a combination thereof.

In some embodiments, the method of any of the preceding embodiments further comprises rotating the transparent workpiece while chemically etching the transparent workpiece.

In some embodiments, the method of any of the preceding embodiments further comprises coupling the transparent workpiece to a workpiece fixture and immersing the transparent workpiece and the workpiece fixture in a chemical etching bath.

In some embodiments, for the method of any of the preceding embodiments, the workpiece fixture comprises a first fixture wall, a second fixture wall, and a plurality of fixture cross-bars coupled to and extending between the first fixture wall and the second fixture wall, wherein one or more grooves extend into at least one of the plurality of fixture cross-bars.

In some embodiments, for the method of any of the preceding embodiments, the dimensionless divergence factor F_{D} comprises a value of from about 10 to about 2000.

In some embodiments, for the method of any of the preceding embodiments, the dimensionless divergence factor F_{D} comprises a value of from about 50 to about 1500.

In some embodiments, for the method of any of the preceding embodiments, the dimensionless divergence factor F_{D} comprises a value of from about 100 to about 1000.

In some embodiments, for the method of any of the preceding embodiments, the aspheric optical element comprises a refractive axicon, a reflective axicon, negative axicon, a spatial light modulator, a diffractive optic, or a cubically shaped optical element.

In some embodiments, for the method of any of the preceding embodiments, the pulsed laser beam has a wavelength λ and wherein the transparent workpiece has combined losses due to linear absorption and scattering less than 20%/mm in the beam propagation direction.

In some embodiments, for the method of any of the preceding embodiments, the beam source comprises a pulsed beam source that produces pulse bursts with from about 1 sub-pulses per pulse burst to about 30 sub-pulses per pulse burst and a pulse burst energy is from about 50 μJ to about 600 μJ per pulse burst.

In some embodiments, a method for processing a transparent workpiece includes forming a plurality of closed contour lines in the transparent workpiece, each closed contour line including a plurality of defects in the transparent workpiece such that each closed contour line defines a closed contour. Forming each closed contour line includes directing a pulsed laser beam oriented along a beam pathway and output by a beam source through an aspheric optical element and into the transparent workpiece such that a portion of the pulsed laser beam directed into the transparent workpiece generates an induced absorption within the transparent workpiece, the induced absorption producing a defect within the transparent workpiece, and the portion of the pulsed laser beam directed into the transparent workpiece includes a wavelength λ, a spot size w₀, and a cross section that comprises a Rayleigh range Z_{R} that is greater than

$${F}_{D} \frac{π {w}_{0 ,}^{2}}{λ} ,$$

where F_{D} is a dimensionless divergence factor comprising a value of 10 or greater. Forming each closed contour line also includes translating the transparent workpiece and the pulsed laser beam relative to each other along the closed contour line, thereby laser forming the plurality of defects along the closed contour line within the transparent workpiece. Further, the method for processing the transparent workpiece also includes etching the transparent workpiece with a chemical etching solution at an etching rate of about 10 μm/min or less to separate portions of the transparent workpiece along each closed contour line, thereby forming a plurality of apertures extending through the transparent workpiece, each aperture comprising an aperture perimeter extending along the closed contour. The plurality of apertures are positioned such that when the transparent workpiece is coupled to an electronic device having one or more speakers, the plurality of apertures are aligned with the one or more speakers, thereby providing acoustic pathways through the transparent workpiece.

In some embodiments, for the method of any of the preceding embodiments, the etching rate is about 5 μm/min or less.

In some embodiments, for the method of any of the preceding embodiments, the etching rate is about 2.5 μm/min or less.

In some embodiments, for the method of any of the preceding embodiments, etching the transparent workpiece removes about 50% or less of a thickness of the transparent workpiece.

In some embodiments, for the method of any of the preceding embodiments, etching the transparent workpiece removes about 25% or less of a thickness of the transparent workpiece.

In some embodiments, for the method of any of the preceding embodiments, etching the transparent workpiece removes about 15% or less of a thickness of the transparent workpiece.

In some embodiments, for the method of any of the preceding embodiments, etching the transparent workpiece removes about 7.5% or less of a thickness of the transparent workpiece.

In some embodiments, for the method of any of the preceding embodiments, a spacing between adjacent defects is about 50 μm or less.

In some embodiments, for the method of any of the preceding embodiments, a spacing between adjacent defects is about 15 μm or less.

In some embodiments, for the method of any of the preceding embodiments, a spacing between adjacent defects is about 10 μm or less.

In some embodiments, for the method of any of the preceding embodiments, a spacing between adjacent defects is about 5 μm or less.

In some embodiments, for the method of any of the preceding embodiments, the transparent workpiece comprises an alkali aluminosilicate glass material.

In some embodiments, for the method of any of the preceding embodiments, the aperture perimeter of each aperture comprises a diameter of from about 100 μm to about 10 mm.

In some embodiments, for the method of any of the preceding embodiments, the aperture perimeter of each aperture comprises a diameter of about 800 μm or less.

In some embodiments, for the method of any of the preceding embodiments, the chemical etching solution comprises a chemical etchant and deionized water and the chemical etchant of the chemical etching solution comprises hydrofluoric acid, nitric acid, hydrochloric acid, sulfuric acid, or combinations thereof.

In some embodiments, for the method of any of the preceding embodiments, the chemical etching solution comprises a chemical etchant and deionized water and the chemical etchant of the chemical etching solution comprises sodium hydroxide or potassium hydroxide.

In some embodiments, for the method of any of the preceding embodiments, the chemical etching solution comprises from about 5M to 20M sodium hydroxide or 5M to 20M potassium hydroxide.

In some embodiments, for the method of any of the preceding embodiments, the chemical etching solution is maintained at a temperature between 70° C. to about 100° C.

In some embodiments, the method of any of the preceding embodiments further comprises rotating the transparent workpiece while chemically etching the transparent workpiece.

In some embodiments, for the method of any of the preceding embodiments, etching the transparent workpiece with the chemical etching solution comprises immersing the transparent workpiece in a chemical etching bath comprising the chemical etching solution.

In some embodiments, for the method of any of the preceding embodiments, the resulting contour has a ratio of top diameter to waist diameter of about 1:0.9 to about 1:0.99.

In some embodiments, for the method of any of the preceding embodiments, etching the transparent workpiece with the chemical etching solution comprises spraying the transparent workpiece from either side while on a horizontal roller system.

In some embodiments, for the method of any of the preceding embodiments, the resulting contour has a ratio of top diameter to waist diameter of about less than 1:0.9.

In some embodiments, for the method of any of the preceding embodiments, the resulting contour has a ratio of top diameter to waist diameter of about 1:0.95 to about 1:1.

In some embodiments, for the method of any of the preceding embodiments, etching the transparent workpiece with the chemical etching solution further comprises agitating the chemical etching solution when the transparent workpiece is immersed in the chemical etching bath.

In some embodiments, for the method of any of the preceding embodiments, the dimensionless divergence factor F_{D} comprises a value of from about 10 to about 2000.

In some embodiments, for the method of any of the preceding embodiments, the aspheric optical element comprises a refractive axicon, a reflective axicon, negative axicon, a spatial light modulator, a diffractive optic, or a cubically shaped optical element.

In some embodiments, for the method of any of the preceding embodiments, the pulsed laser beam has a wavelength λ and wherein the transparent workpiece has combined losses due to linear absorption and scattering less than 20%/mm in the beam propagation direction.

Additional features and advantages of the processes and systems described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts the formation of a closed contour line of defects, according to one or more embodiments described herein;

FIG. 1B schematically depicts an example pulsed laser beam focal line during processing of a transparent workpiece, according to one or more embodiments described herein;

FIG. 2 schematically depicts a beam spot and traversing a closed contour to form a closed contour line of defects in a transparent workpiece, according to one or more embodiments described herein;

FIG. 3 schematically depicts an optical assembly for pulsed laser processing, according to one or more embodiments described herein;

FIG. 4A graphically depicts the relative intensity of laser pulses within an exemplary pulse burst vs. time, according to one or more embodiments described herein;

FIG. 4B graphically depicts relative intensity of laser pulses vs. time within another exemplary pulse burst, according to one or more embodiments described herein;

FIG. 5A schematically depicts an example transparent workpiece comprising a plurality of closed contour lines according to one or more embodiments described herein;

FIG. 5B schematically depicts the example transparent workpiece of FIG. 5A positioned in a chemical etching bath, according to one or more embodiments described herein;

FIG. 5C schematically depicts the example transparent workpiece of FIGS. 5A and 5B after chemical etching such that the transparent workpiece comprises a plurality of apertures, according to one or more embodiments described herein;

FIG. 5D schematically depicts a detailed section of the chemical etching bath of FIG. 5B, according to one or more embodiments shown and described herein;

FIG. 6 schematically depicts an example workpiece fixture for holding a transparent workpiece within a chemical etching bath, according to one or more embodiments described herein; and

FIG. 7 depicts an exploded an example transparent workpiece having a plurality of apertures and an example electronic device having a plurality of speakers aligned with the plurality of apertures of the example transparent workpiece, according to one or more embodiments described herein.

### DETAILED DESCRIPTION

Reference will now be made in detail to embodiments of processes for laser processing transparent workpieces, such as glass workpieces, examples of which are illustrated in the accompanying drawings. Whenever possible, the same reference numerals will be used throughout the drawings to refer to the same or like parts. According to one or more embodiments described herein, a transparent workpiece may be laser processed to form a closed contour line in the transparent workpiece comprising a series of defects that define a desired perimeter of one or more apertures through the transparent workpiece. According to one embodiment, a pulsed laser outputs a pulsed laser beam through an aspheric optical element such that the pulsed laser beam projects a pulsed laser beam focal line that is directed into the transparent workpiece. The pulsed laser beam focal line may be utilized to create a series of defects in the transparent workpiece thereby defining the closed contour line. These defects may be referred to, in various embodiments herein, as line defects, perforations, or nano-perforations in the workpiece. In some embodiments, the process may further include separating the transparent workpiece along the closed contour line, for example, by chemically etching, thereby forming an aperture through the transparent workpiece. Various embodiments of methods and apparatuses for processing a transparent workpiece will be described herein with specific reference to the appended drawings.

While the embodiments of processing a transparent workpiece to form one or more apertures extending through the transparent workpiece may be used in a variety of contexts, the present embodiments are particularly useful for forming apertures in transparent workpieces to create pathways for acoustic transmission through transparent workpieces. For example, a transparent workpiece may be used as a glass cover plate for a phone, tablet and other electronic devices such as computing devices, laptop electronics, televisions, or other consumer electronics, and apertures in the transparent workpiece may be positioned proximate to the speakers of these electronic device to provide an acoustic transmission pathway through the transparent workpieces and thus allow the speakers to output sound in the direction of the user (e.g., through the transparent workpiece) instead of through the sides of the electronic device, away from the user. Providing a single material cover plate having apertures for acoustic transmission provides aesthetic, cost, and design flexibility advantages over previous cover plates. Further, the transparent workpiece may be used as a backplate for a computer keyboard and the apertures may serve as key holes that allow each key of the keyboard to extend through an individual aperture.

Previous methods of forming apertures in transparent workpieces limited the achievable size and shape of these apertures. Apertures desirable for use as acoustic pathways may comprise cross-sectional dimensions (e.g., diameters) of from about 100 μm to about 10 mm, for example, less than 5 mm, less than 3 mm, less than 1 mm, or the like, which are difficult to create using previous methods. Apertures having these cross-sectional dimensions may impede external contamination of the electronics positioned underneath the transparent workpiece, i.e. under the cover plate, while allowing acoustic energy (i.e. sound) to traverse the transparent workpiece. The processing methods described herein increase the design flexibility of apertures formed in transparent workpieces and allow apertures to be formed having small cross sectional dimensions.

The phrase “transparent workpiece,” as used herein, means a workpiece formed from glass or glass-ceramic which is transparent, where the term “transparent,” as used herein, means that the material has an optical absorption of less than about 20% per mm of material depth, such as less than about 10% per mm of material depth for the specified pulsed laser wavelength, or such as less than about 1% per mm of material depth for the specified pulsed laser wavelength. According to one or more embodiments, the transparent workpiece may have a thickness of from about 50 microns (μm) to about 10 mm, such as from about 100 μm to about 5 mm, from about 0.5 mm to about 3 mm, or from about 100 μm to about 2 mm, for example, 100 μm, 250 μm, 300 μm, 500 μm, 700 μm, 1 mm, 1.2 mm, 1.5 mm, 2 mm, 5 mm, 7 mm, or the like.

According to one or more embodiments, the present disclosure provides methods for processing workpieces. As used herein, “laser processing” may include forming contour lines (e.g., closed contour lines) in transparent workpieces, separating transparent workpieces, or combinations thereof. Transparent workpieces may comprise glass workpieces formed from glass compositions, such as borosilicate glass, soda-lime glass, aluminosilicate glass, alkali aluminosilicate glass, alkaline earth aluminosilicate glass, alkaline earth boro-aluminosilicate glass, fused silica, or crystalline materials such as sapphire, silicon, gallium arsenide, or combinations thereof. In some embodiments, the glass may be ion-exchangeable, such that the glass composition can undergo ion-exchange for mechanical strengthening before or after laser processing the transparent workpiece and before or after chemical etching of the transparent workpiece. For example, the transparent workpiece may comprise ion exchanged or ion exchangeable glass, such as Corning Gorilla® Glass available from Corning Incorporated of Corning, N.Y. (e.g., code 2318, code 2319, and code 2320). Further, these ion exchanged glasses may have coefficients of thermal expansion (CTE) of from about 6 ppm/° C. to about 10 ppm/° C. In some embodiments, the glass composition of the transparent workpiece may include greater than about 1.0 mol. % boron and/or compounds containing boron, including, without limitation, B₂O₃. In another embodiment, the glass compositions from which the transparent workpieces are formed include less than or equal to about 1.0 mol. % of oxides of boron and/or compounds containing boron. In some embodiments, the glass compositions from which the transparent workpieces are formed include greater than or equal to about 92.5 wt % of silica. Moreover, the transparent workpiece may comprise other components which are transparent to the wavelength of the laser, for example, crystals such as sapphire or zinc selenide.

Some transparent workpieces may be utilized as display and/or TFT (thin film transistor) substrates. Some examples of such glasses or glass compositions suitable for display or TFT use are EAGLE XG®, CONTEGO, and CORNING LOTUS™ available from Corning Incorporated of Corning, N.Y. The alkaline earth boro-aluminosilicate glass compositions may be formulated to be suitable for use as substrates for electronic applications including, without limitation, substrates for TFTs. The glass compositions used in conjunction with TFTs typically have CTEs similar to that of silicon (such as less than 5×10⁻⁶/K, or even less than 4×10⁻⁶/K, for example, approximately 3×10⁻⁶/K, or about 2.5×10⁻⁶/K to about 3.5×10⁻⁶/K), and have low levels of alkali within the glass. Low levels of alkali (e.g., trace amounts of about 0 wt. % to 2 wt. %, such as less than 1 wt. %, for example, less than 0.5 wt. %) may be used in TFT applications because alkali dopants, under some conditions, leach out of glass and contaminate or “poison” the TFTs, possibly rendering the TFTs inoperable. According to embodiments, the laser cutting processes and chemical etching processes described herein may be used to form apertures within transparent workpieces in a controlled fashion with negligible debris, minimum defects, and low subsurface damage to the edges, preserving workpiece integrity and strength.

The phrase “closed contour line,” as used herein, denotes a line (e.g., a line, a curve, etc.) formed along a closed contour that extends along the surface of a transparent workpiece. The closed contour defines a desired aperture perimeter along which material of the transparent workpiece may be removed to form one or more apertures extending through the transparent workpiece upon exposure to the appropriate processing conditions. The closed contour line generally consists of one or more defects introduced into the transparent workpiece using various techniques. As used herein, a “defect” may include an area of modified material (relative to the bulk material), void space, scratch, flaw, hole, or other deformities in the transparent workpiece which enables separation of material of the transparent workpiece along the closed contour line by application of a chemical etching solution to the transparent workpiece. While not intending to be limited by theory, the chemical etching solution may remove material of the transparent workpiece at and immediately surrounding each defect, thereby enlarging each defect such that voids formed from adjacent defects overlap, ultimately leading to separation of the transparent workpiece along the closed contour line and formation of the aperture extending through the transparent workpiece.

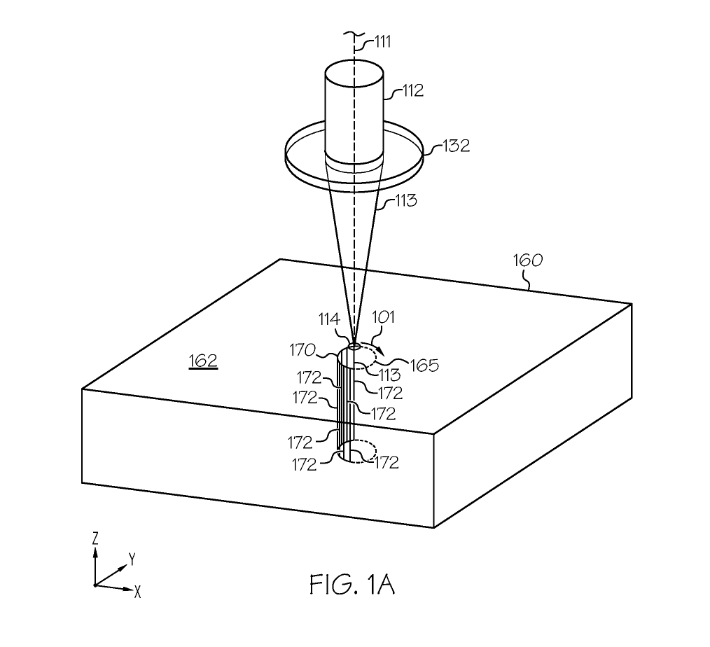

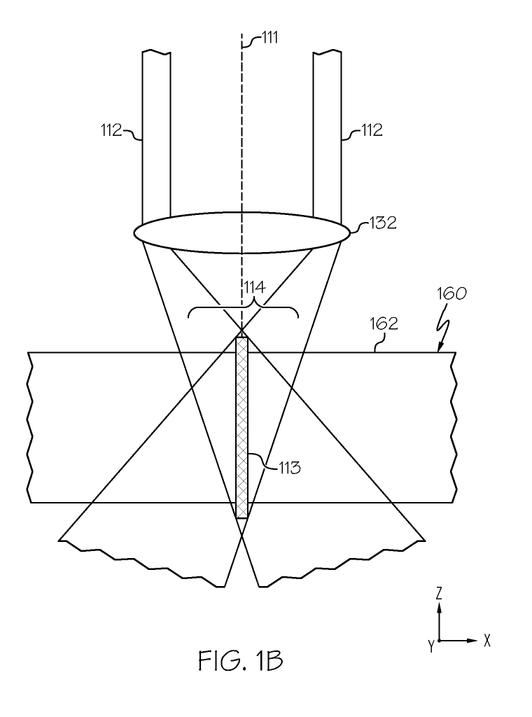

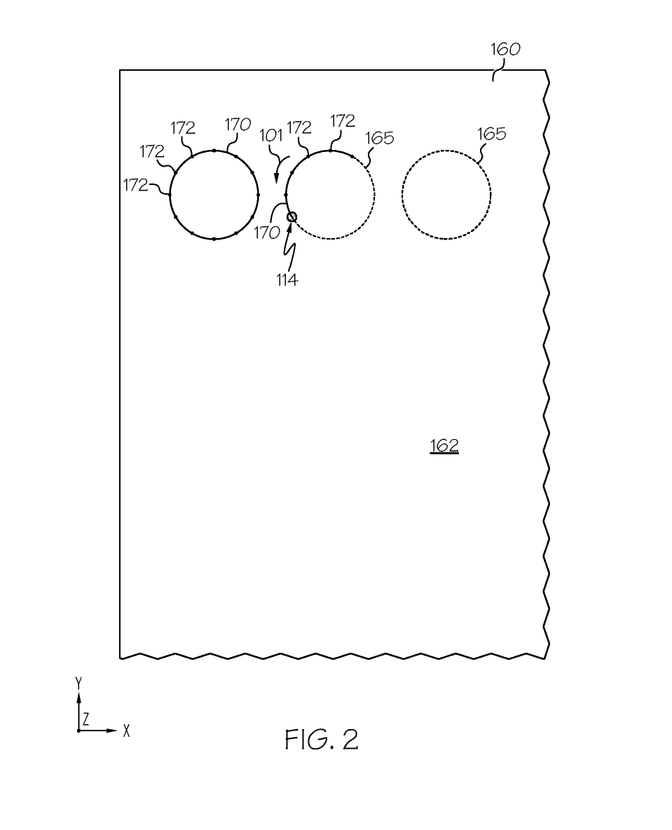

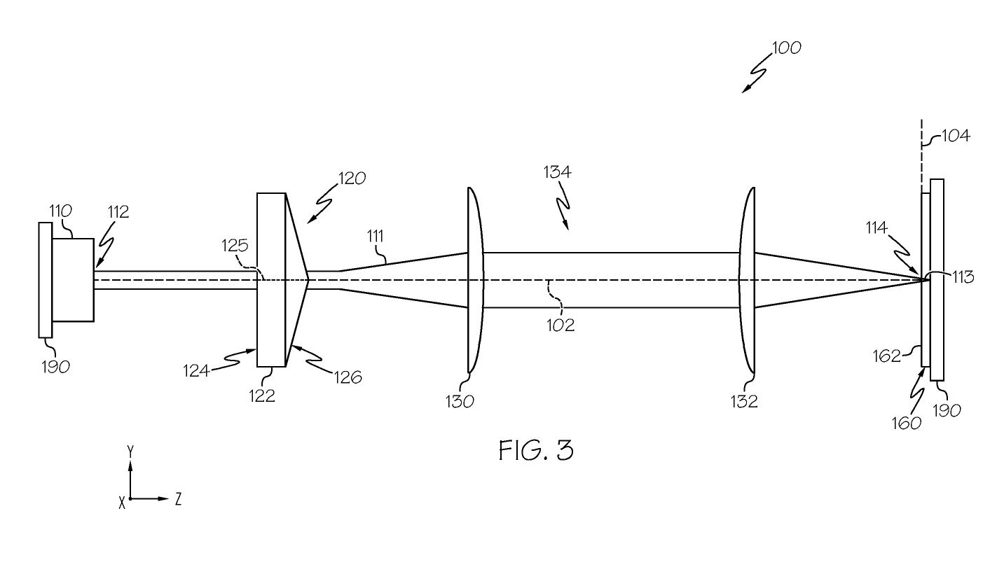

Referring now to FIGS. 1A and 1B by way of example, a transparent workpiece 160, such as a glass workpiece or a glass-ceramic workpiece, is schematically depicted undergoing processing according to the methods described herein. FIGS. 1A and 1B depict the formation of a closed contour line 170 in the transparent workpiece 160, which may be formed by translating a pulsed laser beam 112 and the transparent workpiece 160 relative to one another such that the pulsed laser beam 112 translates relative to the transparent workpiece 160 in a translation direction 101. FIGS. 1A and 1B depict the pulsed laser beam 112 along a beam pathway 111 and oriented such that the pulsed laser beam 112 may be focused into a pulsed laser beam focal line 113 within the transparent workpiece 160 using an aspheric optical element 120 (FIG. 3), for example, an axicon and one or more lenses (e.g., a first lens 130 and a second lens 132, as described below and depicted in FIG. 3). Further, the pulsed laser beam focal line 113 is a portion of a quasi non-diffracting beam, as defined in more detail below.

FIGS. 1A and 1B depict that the pulsed laser beam 112 forms a beam spot 114 projected onto an imaging surface 162 of the transparent workpiece 160. As used herein the “imaging surface” 162 of the transparent workpiece 160 is the surface of the transparent workpiece 160 at which the pulsed laser beam 112 initially contacts the transparent workpiece 160. As also used herein “beam spot” refers to a cross section of a laser beam (e.g., the pulsed laser beam 112) at a point of first contact with a workpiece (e.g., the transparent workpiece 160). In some embodiments, the pulsed laser beam focal line 113 may comprise an axisymmetric cross section in a direction normal the beam pathway 111 (e.g., an axisymmetric beam spot) and in other embodiments, the pulsed laser beam focal line 113 may comprise a non-axisymmetric cross section in a direction normal the beam pathway 111 (e.g., a non-axisymmetric beam spot). As used herein, axisymmetric refers to a shape that is symmetric, or appears the same, for any arbitrary rotation angle made about a central axis, and “non-axisymmetric” refers to a shape that is not symmetric for any arbitrary rotation angle made about a central axis. A circular beam spot is an example of an axisymmetric beam spot and an elliptical beam spot is an example of a non-axisymmetric beam spot. The rotation axis (e.g., the central axis) is most often taken as being the propagation axis of the laser beam (e.g., the beam pathway 111). Example pulsed laser beams comprising a non-axisymmetric beam cross section are described in more detail in U.S. Provisional Pat. App. No. 62/402,337, titled “Apparatus and Methods for Laser Processing Transparent Workpieces Using Non-Axisymmetric Beam Spots,” herein incorporated by reference in its entirety.

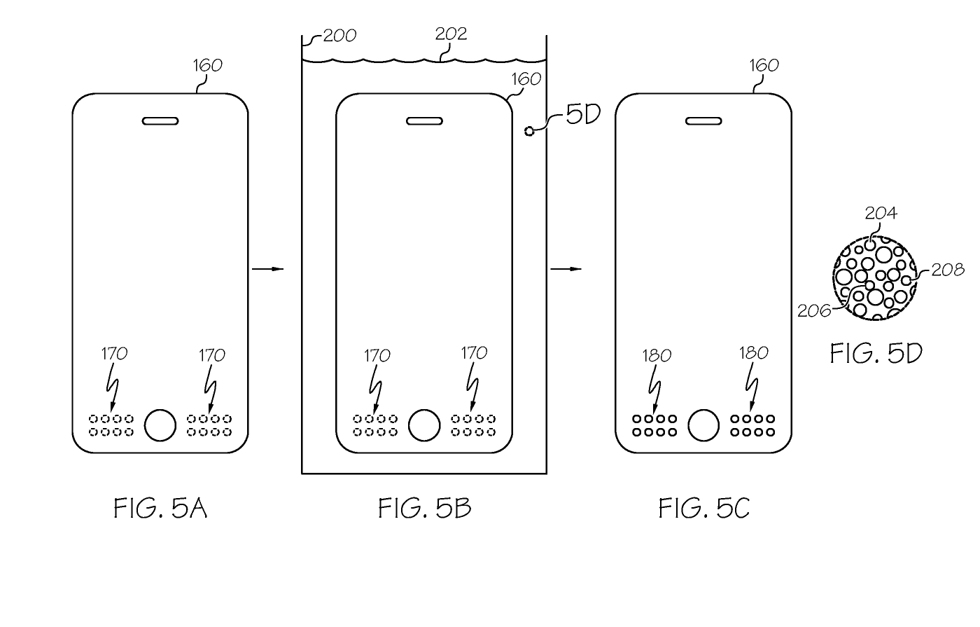

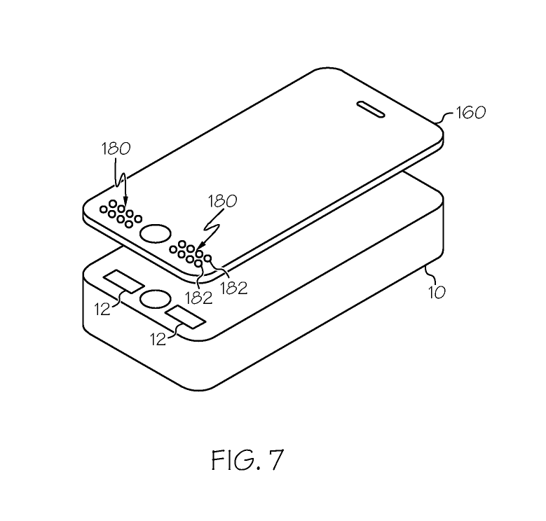

Referring also to FIG. 2, the closed contour line 170 extends along a closed contour 165 which delineates a line of intended separation along which one or more apertures 180 (FIGS. 5C and 7) may be formed in the transparent workpiece 160. The closed contour line 170 comprises a plurality of defects 172 that extend into the surface of the transparent workpiece 160 and establish a path for separation of material of the transparent workpiece 160 enclosed by the closed contour line 170 from the remaining transparent workpiece 160 thereby forming an aperture 180 (FIGS. 5C and 7) extending through the transparent workpiece 160, for example, by applying a chemical etching solution 202 (FIG. 5B) to the transparent workpiece 160, at least along the closed contour line 170.

While the closed contour line 170 is depicted in FIG. 1A and FIG. 2 as a circle, it should be understood that other closed configurations are contemplated and possible including, without limitation, circles, ellipses, squares, hexagons, ovals, regular geometric shapes, irregular shapes, polygonal shapes, arbitrary shapes, and the like. Further, as depicted in FIG. 2, the embodiments described herein may be used to form multiple closed contour lines 170 in a single transparent workpiece 160 and thereby form multiple apertures 180, for example, arrays of apertures 180 (FIGS. 5C and 7). Further, these arrays of apertures 180 may collectively form shapes, for example, text, symbols (e.g., product indicating symbols), or the like. Moreover, these arrays of apertures 180 may be positioned at locations of the transparent workpiece 160 that correspond to the location of one or more speakers 12 of an electronic device 10 in embodiments in which the transparent workpiece 160 is used as cover glass for an electronic device 10 (FIG. 7).

Referring to FIGS. 1A, 1B, and 2, in the embodiments described herein, a pulsed laser beam 112 (with a beam spot 114 projected onto the transparent workpiece 160) may be directed onto the transparent workpiece 160 (e.g., condensed into a high aspect ratio line focus that penetrates through at least a portion of the thickness of the transparent workpiece 160). This forms the pulsed laser beam focal line 113. Further, the beam spot 114 is an example cross section of the pulsed laser beam focal line 113 and when the pulsed laser beam focal line 113 irradiates the transparent workpiece 160 (forming the beam spot 114), the pulsed laser beam focal line 113 penetrates at least a portion of the transparent workpiece 160.

Further, the pulsed laser beam 112 may be translated relative to the transparent workpiece 160 (e.g., in the translation direction 101) to form the plurality of defects 172 of the closed contour line 170. Directing or localizing the pulsed laser beam 112 into the transparent workpiece 160 generates an induced absorption within the transparent workpiece 160 and deposits enough energy to break chemical bonds in the transparent workpiece 160 at spaced locations along the closed contour 165 to form the defects 172. According to one or more embodiments, the pulsed laser beam 112 may be translated across the transparent workpiece 160 by motion of the transparent workpiece 160 (e.g., motion of a translation stage 190 coupled to the transparent workpiece 160), motion of the pulsed laser beam 112 (e.g., motion of the pulsed laser beam focal line 113), or motion of both the transparent workpiece 160 and the pulsed laser beam focal line 113. By translating the pulsed laser beam focal line 113 relative to the transparent workpiece 160, the plurality of defects 172 may be formed in the transparent workpiece 160.

Referring again to FIGS. 1A-2, the pulsed laser beam 112 used to form the defects 172 further has an intensity distribution I(X,Y,Z), where Z is the beam propagation direction of the pulsed laser beam 112, and X and Y are directions orthogonal to the direction of propagation, as depicted in the figures. The X-direction and Y-direction may also be referred to as cross-sectional directions and the X-Y plane may be referred to as a cross-sectional plane. The intensity distribution of the pulsed laser beam 112 in a cross-sectional plane may be referred to as a cross-sectional intensity distribution.

The pulsed laser beam 112 at the beam spot 114 or other cross sections may comprise a quasi-non-diffracting beam, for example, a beam having low beam divergence as mathematically defined below, by propagating the pulsed laser beam 112 (e.g., outputting the pulsed laser beam 112, such as a Gaussian beam, using a beam source 110) through an aspheric optical element 120, as described in more detail below with respect to the optical assembly 100 depicted in FIG. 3. Beam divergence refers to the rate of enlargement of the beam cross section in the direction of beam propagation (i.e., the Z direction). As used herein, the phrase “beam cross section” refers to the cross section of the pulsed laser beam 112 along a plane perpendicular to the beam propagation direction of the pulsed laser beam 112, for example, along the X-Y plane. One example beam cross section discussed herein is the beam spot 114 of the pulsed laser beam 112 projected onto the transparent workpiece 160. Example quasi non-diffracting beams include Gauss-Bessel beams and Bessel beams.

Diffraction is one factor that leads to divergence of pulsed laser beams 112. Other factors include focusing or defocusing caused by the optical systems forming the pulsed laser beams 112 or refraction and scattering at interfaces. Pulsed laser beams 112 for forming the defects 172 of the closed contour line 170 may have beam spots 114 with low divergence and weak diffraction. The divergence of the pulsed laser beam 112 is characterized by the Rayleigh range Z_{R}, which is related to the variance σ² of the intensity distribution and beam propagation factor M² of the pulsed laser beam 112. In the discussion that follows, formulas will be presented using a Cartesian coordinate system. Corresponding expressions for other coordinate systems are obtainable using mathematical techniques known to those of skill in the art. Additional information on beam divergence can be found in the articles entitled “New Developments in Laser Resonators” by A. E. Siegman in SPIE Symposium Series Vol. 1224, p. 2 (1990) and “M² factor of Bessel-Gauss beams” by R. Borghi and M. Santarsiero in Optics Letters, Vol. 22(5), 262 (1997), the disclosures of which are incorporated herein by reference in their entirety. Additional information can also be found in the international standards ISO 11146-1:2005(E) entitled “Lasers and laser-related equipment—Test methods for laser beam widths, divergence angles and beam propagation ratios—Part 1: Stigmatic and simple astigmatic beams”, ISO 11146-2:2005(E) entitled “Lasers and laser-related equipment—Test methods for laser beam widths, divergence angles and beam propagation ratios—Part 2: General astigmatic beams”, and ISO 11146-3:2004(E) entitled “Lasers and laser-related equipment—Test methods for laser beam widths, divergence angles and beam propagation ratios—Part 3: Intrinsic and geometrical laser beam classification, propagation and details of test methods”, the disclosures of which are incorporated herein by reference in their entirety.

The spatial coordinates of the centroid of the intensity profile of the pulsed laser beam 112 having a time-averaged intensity profile I(x,y,z) are given by the following expressions:

$$\begin{matrix}\overline{x} ( z ) = \frac{{\int }_{- ∞}^{∞} {\int }_{- ∞}^{∞} xI ( x , y , z ) dxdy}{{\int }_{- ∞}^{∞} {\int }_{- ∞}^{∞} I ( x , y , z ) dxdy} & ( 1 ) \\ \overline{y} ( z ) = \frac{{\int }_{- ∞}^{∞} {\int }_{- ∞}^{∞} yI ( x , y , z ) dxdy}{{\int }_{- ∞}^{∞} {\int }_{- ∞}^{∞} I ( x , y , z ) dxdy} & ( 2 )\end{matrix}$$

These are also known as the first moments of the Wigner distribution and are described in Section 3.5 of ISO 11146-2:2005(E). Their measurement is described in Section 7 of ISO 11146-2:2005(E).

Variance is a measure of the width, in the cross-sectional (X-Y) plane, of the intensity distribution of the pulsed laser beam 112 as a function of position z in the direction of beam propagation. For an arbitrary laser beam, variance in the X-direction may differ from variance in the Y-direction. We let σₓ²(z) and σ_{y}²(z) represent the variances in the X-direction and Y-direction, respectively. Of particular interest are the variances in the near field and far field limits. We let σ₀ₓ²(z) and σ_{0y}² (z) represent variances in the X-direction and Y-direction, respectively, in the near field limit, and we let σ_{∞x}²(z) and σ_{∞y}²(z) represent variances in the X-direction and Y-direction, respectively, in the far field limit. For a laser beam having a time-averaged intensity profile I(x,y,z) with Fourier transform Ĩ(vₓ,v_{y}) (where vₓ and v_{y} are spatial frequencies in the X-direction and Y-direction, respectively), the near field and far field variances in the X-direction and Y-direction are given by the following expressions:

$$\begin{matrix}{σ}_{0 x}^{2} ( z ) = \frac{{\int }_{- ∞}^{∞} {\int }_{- ∞}^{∞} {x}^{2} I ( x , y , z ) dxdy}{{\int }_{- ∞}^{∞} {\int }_{- ∞}^{∞} I ( x , y , z ) dxdy} & ( 3 ) \\ {σ}_{0 y}^{2} ( z ) = \frac{{\int }_{- ∞}^{∞} {\int }_{- ∞}^{∞} {y}^{2} I ( x , y , z ) dxdy}{{\int }_{- ∞}^{∞} {\int }_{- ∞}^{∞} I ( x , y , z ) dxdy} & ( 4 )\end{matrix}$$

$$\begin{matrix}{σ}_{∞ x}^{2} = \frac{{\int }_{- ∞}^{∞} {\int }_{- ∞}^{∞} {u}_{x}^{2} \tilde{I} ( {v}_{x} , {v}_{y} ) {dv}_{x} {dv}_{y}}{{\int }_{- ∞}^{∞} {\int }_{- ∞}^{∞} \tilde{I} ( {v}_{x} , {v}_{y} ) {dv}_{x} {dv}_{y}} & ( 5 ) \\ {σ}_{∞ y}^{2} = \frac{{\int }_{- ∞}^{∞} {\int }_{- ∞}^{∞} {u}_{y}^{2} \tilde{I} ( {v}_{x} , {v}_{y} ) {dv}_{x} {dv}_{y}}{{\int }_{- ∞}^{∞} {\int }_{- ∞}^{∞} \tilde{I} ( {v}_{x} , {v}_{y} ) {dv}_{x} {dv}_{y}} & ( 6 )\end{matrix}$$

The variance quantities σ₀ₓ²(z), σ_{0y}²(z), σ_{∞x}², and σ_{∞y}² are also known as the diagonal elements of the Wigner distribution (see ISO 11146-2:2005(E)). These variances can be quantified for an experimental laser beam using the measurement techniques described in Section 7 of ISO 11146-2:2005(E). In brief, the measurement uses a linear unsaturated pixelated detector to measure I(x,y) over a finite spatial region that approximates the infinite integration area of the integral equations which define the variances and the centroid coordinates. The appropriate extent of the measurement area, background subtraction and the detector pixel resolution are determined by the convergence of an iterative measurement procedure described in Section 7 of ISO 11146-2:2005(E). The numerical values of the expressions given by equations 1-6 are calculated numerically from the array of intensity values as measured by the pixelated detector.

Through the Fourier transform relationship between the transverse amplitude profile ũ(x,y,z) for an arbitrary optical beam (where I(x,y,z)≡|ũ(x,y,z)|²) and the spatial-frequency distribution \tilde{P}(vₓ,v_{y}, z) for an arbitrary optical beam (where I(vₓ,v_{y})≡|\tilde{P}(vₓ,v_{y}, z)|²), it can be shown that:

σₓ²(z)=σ₀ₓ²(z₀ₓ)+λ²σ_{∞x}²(z−z₀ₓ)² (7)

σ_{y}²(z)=σ_{0y}²(z_{0y})+λ²σ_{∞y}²(z−z_{0y})² (8)

In equations (7) and (8), σ₀ₓ²(z₀ₓ) and σ_{0y}²(z_{0y}) are minimum values of σ₀ₓ²(z) and σ_{0y}²(z), which occur at waist positions z₀ₓ and z_{0y} in the x-direction and y-direction, respectively, and λ is the wavelength of the pulsed laser beam 112. Equations (7) and (8) indicate that σₓ²(z) and σ_{y}²(z) increase quadratically with z in either direction from the minimum values associated with the waist position of the pulsed laser beam 112 (e.g., the waist portion of the pulsed laser beam focal line 113). Further, in the embodiments described herein comprising a beam spot 114 that is axisymmetric and thereby comprises an axisymmetric intensity distribution I(x,y), σₓ²(z)=σ_{y}²(z) and in the embodiments described herein comprising a beam spot 114 that is non-axisymmetric and thereby comprises a non-axisymmetric intensity distribution I(x,y), σₓ²(z)≠σ_{y}²(z), i.e., σₓ²(z)<σ_{y}²(z) or σₓ²(z)>σ_{y}²(z).

Equations (7) and (8) can be rewritten in terms of a beam propagation factor M², where separate beam propagations factors Mₓ² and M_{y}² for the x-direction and the y-direction are defined as:

Mₓ²≡4πσ₀ₓσ_{∞x} (9)

M_{y}²≡4πσ_{0y}σ_{∞y} (10)

Rearrangement of Equations (9) and (10) and substitution into Equations (7) and (8) yields:

$$\begin{matrix}{σ}_{x}^{2} ( z ) = {σ}_{0 x}^{2} ( {z}_{0 x} ) + \frac{{λ}^{2} {M}_{x}^{4}}{{( 4 π {σ}_{0 x} )}^{2}} {( z - {z}_{0 x} )}^{2} & ( 11 ) \\ {σ}_{y}^{2} ( z ) = {σ}_{0 y}^{2} ( {z}_{0 y} ) + \frac{{λ}^{2} {M}_{y}^{4}}{{( 4 π {σ}_{0 y} )}^{2}} {( z - {z}_{0 y} )}^{2} & ( 12 )\end{matrix}$$

which can be rewritten as:

$$\begin{matrix}{σ}_{x}^{2} ( z ) = {σ}_{0 x}^{2} ( {z}_{0 x} ) [ 1 + \frac{{( z - {z}_{0 x} )}^{2}}{{Z}_{Rx}^{2}} ] & ( 13 ) \\ {σ}_{y}^{2} ( z ) = {σ}_{0 y}^{2} ( {z}_{0 y} ) [ 1 + \frac{{( z - {z}_{0 y} )}^{2}}{{Z}_{Ry}^{2}} ] & ( 14 )\end{matrix}$$

where the Rayleigh ranges Z_{Rx} and Z_{Ry} in the x-direction and y-direction, respectively, are given by:

$$\begin{matrix}{Z}_{Rx} = \frac{4 π {σ}_{0 x}^{2}}{{M}_{x}^{2} λ} & ( 15 ) \\ {Z}_{Ry} = \frac{4 π {σ}_{0 y}^{2}}{{M}_{y}^{2} λ} & ( 16 )\end{matrix}$$

The Rayleigh range corresponds to the distance (relative to the position of the beam waist as defined in Section 3.12 of ISO 11146-1:2005(E)) over which the variance of the laser beam doubles (relative to the variance at the position of the beam waist) and is a measure of the divergence of the cross sectional area of the laser beam. Further, in the embodiments described herein comprising a beam spot 114 that is axisymmetric and thereby comprises an axisymmetric intensity distribution I(x,y), Z_{Rx}=Z_{Ry} and in the embodiments described herein comprising a beam spot 114 that is non-axisymmetric and thereby comprises a non-axisymmetric intensity distribution I(x,y), Z_{Rx}≠Z_{Ry}, i.e., Z_{Rx}<Z_{Ry} or Z_{Rx}>Z_{Ry}. The Rayleigh range can also be observed as the distance along the beam axis at which the optical intensity decays to one half of its value observed at the beam waist location (location of maximum intensity). Laser beams with large Rayleigh ranges have low divergence and expand more slowly with distance in the beam propagation direction than laser beams with small Rayleigh ranges.

The formulas above can be applied to any laser beam (not just Gaussian beams) by using the intensity profile I(x,y,z) that describes the laser beam. In the case of the TEM₀₀ mode of a Gaussian beam, the intensity profile is given by:

$$I ( x , y ) = \frac{\sqrt{π}}{2} {w}_{o} {e}^{\frac{- 2 ( {x}^{2} + {y}^{2} )}{{w}_{o}^{2}}} \qquad ( 17 )$$

where wₒ is the radius (defined as the radius at which beam intensity decreases to 1/e² of the peak beam intensity of the beam at a beam waist position zₒ. From Equation (17) and the above formulas, we obtain the following results for a TEM₀₀ Gaussian beam:

$$\begin{matrix}{σ}_{0 x}^{2} = {σ}_{0 y}^{2} = \frac{{w}_{o}^{2}}{4} & ( 18 ) \\ {σ}_{∞ x}^{2} = {σ}_{∞ y}^{2} = \frac{1}{4 {π}^{2} {w}_{o}^{2}} & ( 19 ) \\ {M}_{x}^{2} = 4 π {σ}_{0 x} {σ}_{∞ x} = 1 & ( 20 ) \\ {M}_{y}^{2} = 4 π {σ}_{0 y} {σ}_{∞ y} = 1 & ( 21 ) \\ {Z}_{Rx} = \frac{4 π {σ}_{0 x}^{2}}{{M}_{x}^{2} λ} = \frac{π {w}_{0}^{2}}{λ} & ( 22 ) \\ {Z}_{Ry} = \frac{4 π {σ}_{0 y}^{2}}{{M}_{y}^{2} λ} = \frac{π {w}_{0}^{2}}{λ} & ( 23 ) \\ {w}^{2} ( z ) = {w}_{0}^{2} + \frac{{λ}^{2}}{{( π {w}_{0} )}^{2}} {( z - {z}_{0} )}^{2} = {w}_{0}^{2} [ 1 + \frac{{( z - {z}_{0} )}^{2}}{{Z}_{R}^{2}} ] & ( 24 )\end{matrix}$$

where Z_{R}=Z_{Rx}=Z_{Ry}. For Gaussian beams, it is further noted that M²=Mₓ²=M_{y}²=1.

Beam cross section is characterized by shape and dimensions. The dimensions of the beam cross section are characterized by a spot size of the beam. For a Gaussian beam, spot size is frequently defined as the radial extent at which the intensity of the beam decreases to 1/e² of its maximum value, denoted in Equation (17) as W₀. The maximum intensity of a Gaussian beam occurs at the center (x=0 and y=0 (Cartesian) or r=0 (cylindrical)) of the intensity distribution and radial extent used to determine spot size is measured relative to the center.

Beams with axisymmetric (i.e. rotationally symmetric around the beam propagation axis Z) cross sections can be characterized by a single dimension or spot size that is measured at the beam waist location as specified in Section 3.12 of ISO 11146-1:2005(E). For a Gaussian beam, Equation (17) shows that spot size is equal to wₒ, which from Equation (18) corresponds to 2σ₀ₓ or 2σ_{0y}. For an axisymmetric beam having an axisymmetric cross section, such as a circular cross section, σ₀ₓ=σ_{0y}. Thus, for axisymmetric beams, the cross section dimension may be characterized with a single spot size parameter, where wₒ=2σ₀. Spot size can be similarly defined for non-axisymmetric beam cross sections where, unlike an axisymmetric beam, σ₀ₓ≠σ_{0y}. Thus, when the spot size of the beam is non-axisymmetric, it is necessary to characterize the cross-sectional dimensions of a non-axisymmetric beam with two spot size parameters: wₒₓ and w_{oy} in the x-direction and y-direction, respectively, where

wₒₓ=2σ₀ₓ (25)

w_{oy}=2σ_{0y} (26)

Further, the lack of axial (i.e. arbitrary rotation angle) symmetry for a non-axisymmetric beam means that the results of a calculation of values of σ₀ₓ and σ_{0y} will depend on the choice of orientation of the X-axis and Y-axis. ISO 11146-1:2005(E) refers to these reference axes as the principal axes of the power density distribution (Section 3.3-3.5) and in the following discussion we will assume that the X and Y axes are aligned with these principal axes. Further, an angle ϕ about which the X-axis and Y-axis may be rotated in the cross-sectional plane (e.g., an angle of the X-axis and Y-axis relative to reference positions for the X-axis and Y-axis, respectively) may be used to define minimum (w_{o,min}) and maximum values (w_{o,max}) of the spot size parameters for a non-axisymmetric beam:

w_{o,min}=2σ_{0,min} (27)

w_{o,max}=2σ_{0,max} (28)

where 2σ_{0,min}=2σ₀ₓ(ϕ_{min,x})=2σ_{0y}(ϕ_{min,y}) and 2σ_{0,max}=2σ₀ₓ(ϕ_{max,x})=2σ_{0y}(ϕ_{max,y}) The magnitude of the axial asymmetry of the beam cross section can be quantified by the aspect ratio, where the aspect ratio is defined as the ratio of w_{o,max} to w_{o,min}. An axisymmetric beam cross section has an aspect ratio of 1.0, while elliptical and other non-axisymmetric beam cross sections have aspect ratios greater than 1.0, for example, greater than 1.1, greater than 1.2, greater than 1.3, greater than 1.4, greater than 1.5, greater than 1.6, greater than 1.7, greater than 1.8, greater than 1.9, greater than 2.0, greater than 3.0, greater than 5.0, greater than 10.0, or the like

To promote uniformity of defects 172 in the beam propagation direction (e.g. depth dimension of the transparent workpiece 160), a pulsed laser beam 112 having low divergence may be used. In one or more embodiments, pulsed laser beams 112 having low divergence may be utilized for forming defects 172. As noted above, divergence can be characterized by the Rayleigh range. For non-axisymmetric beams, Rayleigh ranges for the principal axes X and Y are defined by Equations (15) and (16) for the X-direction and Y-direction, respectively, where it can be shown that for any real beam, Mₓ²>1 and M_{y}²>1 and where σ₀ₓ², and σ_{0y}² are determined by the intensity distribution of the laser beam. For symmetric beams, Rayleigh range is the same in the X-direction and Y-direction and is expressed by Equation (22) or Equation (23). Low divergence correlates with large values of the Rayleigh range and weak diffraction of the laser beam.

While not intending to be limited by theory, defects 172 with a uniform cross section along the depth dimension of the transparent workpiece 160 may more uniformly interact with a chemical etching solution along the depth dimension of the transparent workpiece 160 than defects 172 with a non-uniform cross section. In other words, the chemical etchant may more uniformly remove material of the transparent workpiece 160 surrounding the defect 172, widening each defect 172 of the closed contour line 170 at a more uniform pace, thereby minimizing the etching time required to separate material of the transparent workpiece 160 positioned within the closed contour line 170 from the rest of the transparent workpiece 160 to form the aperture 180 through the depth dimension of the transparent workpiece 160 and also minimizing the amount of material removed from the transparent workpiece 160 (i.e., minimize thickness reduction).

Beams with Gaussian intensity profiles may be less preferred for laser processing to form defects 172 because, when focused to small enough spot sizes (such as spot sizes in the range of microns, such as about 1-5 μm or about 1-10 μm) to enable available laser pulse energies to modify materials such as glass, they are highly diffracting and diverge significantly over short propagation distances. To achieve low divergence, it is desirable to control or optimize the intensity distribution of the pulsed laser beam to reduce diffraction. Pulsed laser beams may be non-diffracting or weakly diffracting. Weakly diffracting laser beams include quasi-non-diffracting laser beams. Representative weakly diffracting laser beams include Bessel beams, Gauss-Bessel beams, Airy beams, Weber beams, and Mathieu beams.

For non-axisymmetric beams, the Rayleigh ranges Z_{Rx} and Z_{Ry} are unequal. Equations (15) and (16) indicate that Z_{Rx} and Z_{Ry} depend on σ₀ₓ and σ_{0y}, respectively, and above we noted that the values of σ₀ₓ and σ_{0y} depend on the orientation of the X-axis and Y-axis. The values of Z_{Rx} and Z_{Ry} will accordingly vary, and each will have a minimum value and a maximum value that correspond to the principal axes, with the minimum value of Z_{Rx} being denoted as Z_{Rx,min} and the minimum value of Z_{Ry} being denoted Z_{Ry,min} for an arbitrary beam profile Z_{Rx,min} and Z_{Ry,min} can be shown to be given by

$$\begin{matrix}{Z}_{Rx , min} = \frac{4 π {σ}_{0 , min}^{2}}{{M}_{x}^{2} λ} & ( 29 ) \\ and & \\ {Z}_{Ry , min} = \frac{4 π {σ}_{0 , min}^{2}}{{M}_{y}^{2} λ} & ( 30 )\end{matrix}$$

Since divergence of the laser beam occurs over a shorter distance in the direction having the smallest Rayleigh range, the intensity distribution of the pulsed laser beam 112 used to form defects 172 may be controlled so that the minimum values of Z_{Rx} and Z_{Ry} (or for axisymmetric beams, the value of Z_{R}) are as large as possible. Since the minimum value Z_{Rx,min} of Z_{Rx} and the minimum value Z_{Ry,min} of Z_{Ry} differ for a non-axisymmetric beam, a pulsed laser beam 112 may be used with an intensity distribution that makes the smaller of Z_{Rx,min} and Z_{Ry,min} as large as possible when forming damage regions.

In different embodiments, the smaller of Z_{Rx,min} and Z_{Ry,min} (or for axisymmetric beams, the value of Z_{R}) is greater than or equal to 50 μm, greater than or equal to 100 μm, greater than or equal to 200 μm, greater than or equal to 300 μm, greater than or equal to 500 μm, greater than or equal to 1 mm, greater than or equal to 2 mm, greater than or equal to 3 mm, greater than or equal to 5 mm, in the range from 50 μm to 10 mm, in the range from 100 μm to 5 mm, in the range from 200 μm to 4 mm, in the range from 300 μm to 2 mm, or the like.

The values and ranges for the smaller of Z_{Rx,min} and Z_{Ry,min} (or for axisymmetric beams, the value of Z_{R}) specified herein are achievable for different wavelengths to which the workpiece is transparent through adjustment of the spot size parameter w_{o,min} defined in Equation (27). In different embodiments, the spot size parameter w_{o,min} is greater than or equal to 0.25 μm, greater than or equal to 0.50 μm, greater than or equal to 0.75 μm, greater than or equal to 1.0 μm, greater than or equal to 2.0 μm, greater than or equal to 3.0 μm, greater than or equal to 5.0 μm, in the range from 0.25 μm to 10 μm, in the range from 0.25 μm to 5.0 μm, in the range from 0.25 μm to 2.5 μm, in the range from 0.50 μm to 10 μm, in the range from 0.50 μm to 5.0 μm, in the range from 0.50 μm to 2.5 μm, in the range from 0.75 μm to 10 μm, in the range from 0.75 μm to 5.0 μm, in the range from 0.75 μm to 2.5 μm, or the like.

Non-diffracting or quasi non-diffracting beams generally have complicated intensity profiles, such as those that decrease non-monotonically vs. radius. By analogy to a Gaussian beam, an effective spot size w_{o,eff} can be defined for non-axisymmetric beams as the shortest radial distance, in any direction, from the radial position of the maximum intensity (r=0) at which the intensity decreases to 1/e² of the maximum intensity. Further, for axisymmetric beams w_{o,eff} is the radial distance from the radial position of the maximum intensity (r=0) at which the intensity decreases to 1/e² of the maximum intensity. A criterion for Rayleigh range based on the effective spot size w_{o,eff} for non-axisymmetric beams or the spot size wₒ for axisymmetric beams can be specified as non-diffracting or quasi non-diffracting beams for forming damage regions using equation (31) for non-axisymmetric beams of equation (32) for axisymmetric beams, below:

$$\begin{matrix}Smaller of {Z}_{Rx , min} , {Z}_{Ry , min} > {F}_{D} \frac{π {w}_{0 , eff}^{2}}{λ} & ( 31 ) \\ {Z}_{R} > {F}_{D} \frac{π {w}_{0}^{2}}{λ} & ( 32 )\end{matrix}$$

where F_{D} is a dimensionless divergence factor having a value of at least 10, at least 50, at least 100, at least 250, at least 500, at least 1000, in the range from 10 to 2000, in the range from 50 to 1500, in the range from 100 to 1000. By comparing Equation (31) to Equation (22) or (23), one can see that for a non-diffracting or quasi non-diffracting beam the distance, Smaller of Z_{Rx,min,} Z_{Ry,min}, in Equation (31), over which the effective beam size doubles, is F_{D} times the distance expected if a typical Gaussian beam profile were used. The dimensionless divergence factor F_{D} provides a criterion for determining whether or not a laser beam is quasi-non-diffracting. As used herein, the pulsed laser beam 112 is considered quasi-non-diffracting if the characteristics of the laser beam satisfy Equation (31) or Equation (32) with a value of F_{D}≥10. As the value of F_{D} increases, the pulsed laser beam 112 approaches a more nearly perfectly non-diffracting state. Moreover, it should be understood that Equation (32) is merely a simplification of Equation (31) and as such, Equation (31) mathematically describes the dimensionless divergence factor F_{D} for both axisymmetric and non-axisymmetric pulsed laser beams 112.

Referring now to FIG. 3, an optical assembly 100 for producing a pulsed laser beam 112 that that is quasi-non-diffracting and forms the pulsed laser beam focal line 113 at the transparent workpiece 160 using the aspheric optical element 120 (e.g., an axicon 122) is schematically depicted. The optical assembly 100 includes a beam source 110 that outputs the pulsed laser beam 112, and a first and second lens 130, 132.

Further, the transparent workpiece 160 may be positioned such that the pulsed laser beam 112 output by the beam source 110 irradiates the transparent workpiece 160, for example, after traversing the aspheric optical element 120 and thereafter, both the first lens 130 and the second lens 132. An optical axis 102 extends between the beam source 110 and the transparent workpiece 160 along the Z-axis such that when the beam source 110 outputs the pulsed laser beam 112, the beam pathway 111 of the pulsed laser beam 112 extends along the optical axis 102. As used herein “upstream” and “downstream” refer to the relative position of two locations or components along the beam pathway 111 with respect to the beam source 110. For example, a first component is upstream from a second component if the pulsed laser beam 112 traverses the first component before traversing the second component. Further, a first component is downstream from a second component if the pulsed laser beam 112 traverses the second component before traversing the first component.

Referring still to FIG. 3, the beam source 110 may comprise any known or yet to be developed beam source 110 configured to output pulsed laser beams 112. In operation, the defects 172 of the closed contour line 170 (FIGS. 1A and 2) are produced by interaction of the transparent workpiece 160 with the pulsed laser beam 112 output by the beam source 110. In some embodiments, the beam source 110 may output a pulsed laser beam 112 comprising a wavelength of for example, 1064 nm, 1030 nm, 532 nm, 530 nm, 355 nm, 343 nm, or 266 nm, or 215 nm. Further, the pulsed laser beam 112 used to form defects 172 in the transparent workpiece 160 may be well suited for materials that are transparent to the selected pulsed laser wavelength.

Suitable laser wavelengths for forming defects 172 are wavelengths at which the combined losses of linear absorption and scattering by the transparent workpiece 160 are sufficiently low. In embodiments, the combined losses due to linear absorption and scattering by the transparent workpiece 160 at the wavelength are less than 20%/mm, or less than 15%/mm, or less than 10%/mm, or less than 5%/mm, or less than 1%/mm, where the dimension “/mm” means per millimeter of distance within the transparent workpiece 160 in the beam propagation direction of the pulsed laser beam 112 (e.g., the Z direction). Representative wavelengths for many glass workpieces include fundamental and harmonic wavelengths of Nd³⁺ (e.g. Nd³⁺:YAG or Nd³⁺:YVO₄ having fundamental wavelength near 1064 nm and higher order harmonic wavelengths near 532 nm, 355 nm, and 266 nm). Other wavelengths in the ultraviolet, visible, and infrared portions of the spectrum that satisfy the combined linear absorption and scattering loss requirement for a given substrate material can also be used.

In operation, the pulsed laser beam 112 output by the beam source 110 may create multi-photon absorption (MPA) in the transparent workpiece 160. MPA is the simultaneous absorption of two or more photons of identical or different frequencies that excites a molecule from one state (usually the ground state) to a higher energy electronic state (i.e., ionization). The energy difference between the involved lower and upper states of the molecule is equal to the sum of the energies of the involved photons. MPA, also called induced absorption, can be a second-order or third-order process (or higher order), for example, that is several orders of magnitude weaker than linear absorption. It differs from linear absorption in that the strength of second-order induced absorption may be proportional to the square of the light intensity, for example, and thus it is a nonlinear optical process.

The perforation step that creates the closed contour line 170 (FIGS. 1A and 2) may utilize the beam source 110 (e.g., an ultra-short pulse laser) in combination with the aspheric optical element 120, the first lens 130, and the second lens 132, to project the beam spot 114 on the transparent workpiece 160 and generate the pulsed laser beam focal line 113. The pulsed laser beam focal line 113 comprises a quasi non-diffracting beam, such as a Gauss-Bessel beam or Bessel beam, as defined above, and may fully perforate the transparent workpiece 160 to form defects 172 in the transparent workpiece 160, which may form the closed contour line 170. In some embodiments, the pulse duration of the individual pulses is in a range of from about 1 femtosecond to about 200 picoseconds, such as from about 1 picosecond to about 100 picoseconds, 5 picoseconds to about 20 picoseconds, or the like, and the repetition rate of the individual pulses may be in a range from about 1 kHz to 4 MHz, such as in a range from about 10 kHz to about 3 MHz, or from about 10 kHz to about 650 kHz.

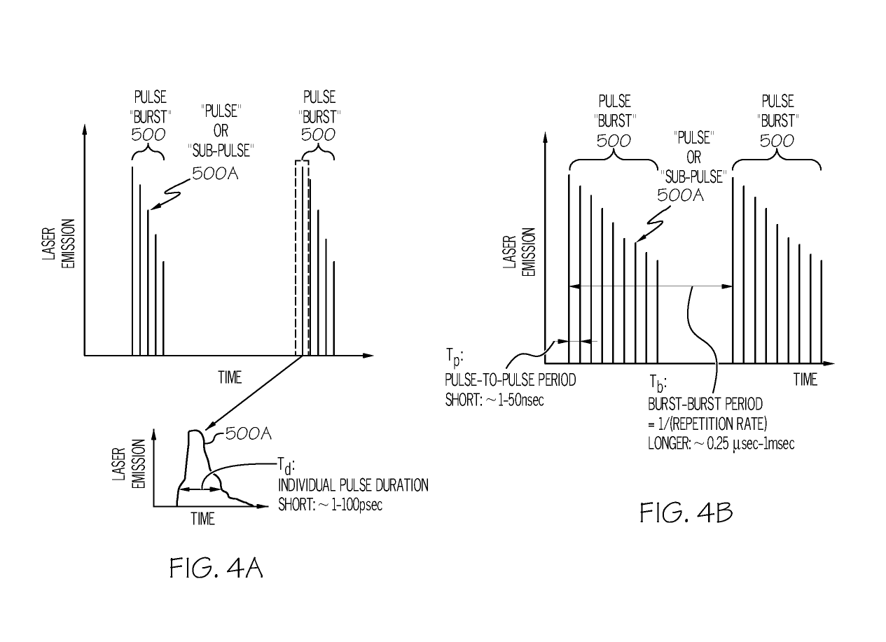

Referring also to FIGS. 4A and 4B, in addition to a single pulse operation at the aforementioned individual pulse repetition rates, the pulses may be produced in pulse bursts 500 of two sub-pulses 500A or more (such as, for example, 3 sub-pulses, 4 sub-pulses, 5 sub-pulses, 10 sub-pulses, 15 sub-pulses, 20 sub-pulses, or more per pulse burst, such as from 2 to 30 sub-pulses per pulse burst 500, or from 5 to 20 sub-pulses per pulse burst 500) or a single pulse. While not intending to be limited by theory, a pulse burst is a short and fast grouping of sub-pulses that creates an optical energy interaction with the material (i.e. MPA in the material of the transparent workpiece 160) on a time scale not easily accessible using a single-pulse operation. While still not intending to be limited by theory, the energy within a pulse burst (i.e. the pulse burst energy) is conserved. As an illustrative example, for a pulse burst having an energy of 100 μJ per pulse burst and 2 sub-pulses, the 100 μJ per pulse burst energy is split between the 2 sub-pulses for an average energy of 50 μJ per sub-pulse. As another illustrative example, for a pulse burst having an energy of 100 μJ per pulse burst and 10 sub-pulses, the 100 μJ per pulse burst is split amongst the 10 sub-pulses for an average energy of 10 μJ per sub-pulse. Further, the energy distribution among the sub-pulses of a pulse burst does not need to be uniform. In fact, in some instances, the energy distribution among the sub-pulses of a pulse burst is in the form of an exponential decay, where the first sub-pulse of the pulse burst contains the most energy, the second sub-pulse of the pulse burst contains slightly less energy, the third sub-pulse of the pulse burst contains even less energy, and so on. However, other energy distributions within an individual pulse burst are also possible, where the exact energy of each sub-pulse can be tailored to effect different amounts of modification to the transparent workpiece 160.

While still not intending to be limited by theory, when the defects 172 of the closed contour line 170 are formed with pulse bursts having at least two sub-pulses, the force necessary to separate the transparent workpiece 160 along closed contour line 170 (i.e. the maximum break resistance) is reduced compared to the maximum break resistance of a closed contour line 170 of the same shape with the same spacing between adjacent defects 172 in an identical transparent workpiece 160 that is formed using a single pulse laser. For example, the maximum break resistance of a closed contour line 170 formed using a single pulse is at least two times greater than the maximum break resistance of a closed contour line 170 formed using a pulse burst having 2 or more sub-pulses. Further, the difference in maximum break resistance between a closed contour line 170 formed using a single pulse and a closed contour line 170 formed using a pulse burst having 2 sub-pulses is greater than the difference in maximum break resistance between a closed contour line 170 formed using a pulse burst having 2 sub-pulses and a pulse burst having 3 sub-pulses. Thus, pulse bursts may be used to form closed contour lines 170 that separate easier than closed contour lines 170 formed using a single pulse laser.

Referring still to FIGS. 4A and 4B, the sub-pulses 500A within the pulse burst 500 may be separated by a duration that is in a range from about 1 nsec to about 50 nsec, for example, from about 10 nsec to about 30 nsec, such as about 20 nsec. In other embodiments, the sub-pulses 500A within the pulse burst 500 may be separated by a duration of up to 100 psec (for example, 0.1 psec, 5 psec, 10 psec, 15 psec, 18 psec, 20 psec, 22 psec, 25 psec, 30 psec, 50 psec, 75 psec, or any range therebetween). For a given laser, the time separation Tₚ (FIG. 4B) between adjacent sub-pulses 500A within a pulse burst 500 may be relatively uniform (e.g., within about 10% of one another). For example, in some embodiments, each sub-pulse 500A within a pulse burst 500 is separated in time from the subsequent sub-pulse by approximately 20 nsec (50 MHz). Further, the time between each pulse burst 500 may be from about 0.25 microseconds to about 1000 microseconds, e.g., from about 1 microsecond to about 10 microseconds, or from about 3 microseconds to about 8 microseconds.

In some of the exemplary embodiments of the beam source 110 described herein, the time separation T_{b} (FIG. 4B) is about 5 microseconds for the beam source 110 outputting a pulsed laser beam 112 comprising a burst repetition rate of about 200 kHz. The laser burst repetition rate is related to the time T_{b} between the first pulse in a burst to the first pulse in the subsequent burst (laser burst repetition rate=1/T_{b}). In some embodiments, the laser burst repetition rate may be in a range of from about 1 kHz to about 4 MHz. In embodiments, the laser burst repetition rates may be, for example, in a range of from about 10 kHz to 650 kHz. The time T_{b} between the first pulse in each burst to the first pulse in the subsequent burst may be from about 0.25 microsecond (4 MHz burst repetition rate) to about 1000 microseconds (1 kHz burst repetition rate), for example from about 0.5 microseconds (2 MHz burst repetition rate) to about 40 microseconds (25 kHz burst repetition rate), or from about 2 microseconds (500 kHz burst repetition rate) to about 20 microseconds (50 k Hz burst repetition rate). The exact timing, pulse duration, and burst repetition rate may vary depending on the laser design, but short pulses (T_{d}<20 psec and, in some embodiments, T_{d}≤15 psec) of high intensity have been shown to work particularly well.

The burst repetition rate may be in a range of from about 1 kHz to about 2 MHz, such as from about 1 kHz to about 200 kHz. Bursting or producing pulse bursts 500 is a type of laser operation where the emission of sub-pulses 500A is not in a uniform and steady stream but rather in tight clusters of pulse bursts 500. The pulse burst laser beam may have a wavelength selected based on the material of the transparent workpiece 160 being operated on such that the material of the transparent workpiece 160 is substantially transparent at the wavelength. The average laser power per burst measured at the material may be at least about 40 μJ per mm of thickness of material. For example, in embodiments, the average laser power per burst may be from about 40 μJ/mm to about 2500 μJ/mm, or from about 500 μJ/mm to about 2250 μJ/mm. In a specific example, for 0.5 mm to 0.7 mm thick Corning EAGLE XG® transparent workpiece, pulse bursts of from about 300 μJ to about 600 μJ may cut and/or separate the workpiece, which corresponds to an exemplary range of about 428 μJ/mm to about 1200 μJ/mm (i.e., 300 μJ/0.7 mm for 0.7 mm EAGLE XG® glass and 600 μJ/0.5 mm for a 0.5 mm EAGLE XG® glass).

The energy required to modify the transparent workpiece 160 is the pulse energy, which may be described in terms of pules burst energy (i.e., the energy contained within a pulse burst 500 where each pulse burst 500 contains a series of sub-pulses 500A), or in terms of the energy contained within a single laser pulse. The pulse energy (for example, the pulse burst energy or the energy of a single laser pulse) may be from about 25 μJ to about 750 μJ, e.g., from about 50 μJ to about 500 μJ, or from about 50 μJ to about 250 μJ. For some glass compositions, the pulse energy may be from about 100 μJ to about 250 μJ. However, for display or TFT glass compositions, the pulse energy may be higher (e.g., from about 300 μJ to about 500 μJ, or from about 400 μJ to about 600 μJ, depending on the specific glass composition of the transparent workpiece 160).

While not intending to be limited by theory, the use of a pulsed laser beam 112 capable of generating pulse bursts is advantageous for cutting or modifying transparent materials, for example glass. In contrast with the use of single pulses spaced apart in time by the repetition rate of the single-pulsed laser, the use of a burst sequence that spreads the pulse energy over a rapid sequence of pulses within the burst allows access to larger timescales of high intensity interaction with the material than is possible with single-pulse lasers. Further, using pulse bursts is advantageous for forming closed contour lines 170 comprising the defects 172 that are separated from the transparent workpiece 160 using chemical etching, as described herein. In particular, pulse bursts facilitate formation of adjacent defects 172 that have connected or nearly connected cracks, allowing a chemical etching solution 202 (FIGS. 5A-5C) to rapidly penetrate through the depth of the defects 172, minimizing the amount of material of the transparent workpiece 160 removed and the amount of byproducts formed when separating the closed contour line 170 and forming apertures 180, as described in more detail below. The use of pulse bursts (as opposed to a single pulse operation) increases the size (e.g., the cross-sectional size) of the defects 172, which facilitates the connection of adjacent defects 172 when separating the closed contour 170 to form the apertures 180, thereby minimizing crack formation from the aperture 180 into the interior of the transparent workpiece 180.

Further, using a pulse burst to form defects 172 increases the randomness of the orientation of cracks extending outward from each defect 172 into the such that individual cracks extending outward from defects 172 do not influence or otherwise bias the separation of the closed contour line 170 to form the corresponding aperture 180 such that separation of the defects 172 follows the closed contour line 170. Moreover, the use of pulse bursts to form defects 172 of the closed contour line 170 facilitates separation of closed contour lines 170 having rounded shapes (without angled corners) via efficient connection of adjacent defects 172 when separating the closed contour line 170. While not intending to be limited by theory, rounded corners cause less cracks to extend outward from the defects 172 into the transparent workpiece 160 during separation than angled corners.

Referring again to FIG. 3, the aspheric optical element 120 is positioned within the beam pathway 111 between the beam source 110 and the transparent workpiece 160. In operation, propagating the pulsed laser beam 112, e.g., an incoming Gaussian beam, through the aspheric optical element 120 may alter the pulsed laser beam 112 such that the portion of the pulsed laser beam 112 propagating beyond the aspheric optical element 120 is quasi-non-diffracting, as described above. The aspheric optical element 120 may comprise any optical element comprising an aspherical shape. In some embodiments, the aspheric optical element 120 may comprise a conical wavefront producing optical element, such as an axicon lens, for example, a negative refractive axicon lens, a positive refractive axicon lens, a reflective axicon lens, a diffractive axicon lens, a programmable spatial light modulator axicon lens (e.g., a phase axicon), or the like.

In some embodiments, the aspheric optical element 120 comprises at least one aspheric surface whose shape is mathematically described as: z′=(cr²/1)+(1−(1+k)(c²r²))^{1/2}+(a₁r+a₂r²+a₃r³+a₄r⁴+a₅r⁵+a₆r⁶+a₇r⁷+a₈r⁸+a₉r⁹+a₁₀r¹⁰+a₁₁r¹¹+a₁₂r¹² where z′ is the surface sag of the aspheric surface, r is the distance between the aspheric surface and the optical axis 102 in a radial direction (e.g., in an X-direction or a Y-direction), c is the surface curvature of the aspheric surface (i.e. cᵢ=1/Rᵢ, where R is the surface radius of the aspheric surface), k is the conic constant, and coefficients a₁ are the first through the twelfth order aspheric coefficients or higher order aspheric coefficients (polynomial aspheres) describing the aspheric surface. In one example embodiment, at least one aspheric surface of the aspheric optical element 120 includes the following coefficients a₁−a₇, respectively: −0.085274788; 0.065748845; 0.077574995; −0.054148636; 0.022077021; −0.0054987472; 0.0006682955; and the aspheric coefficients a₈−a₁₂ are 0. In this embodiment, the at least one aspheric surface has the conic constant k=0. However, because the a₁ coefficient has a nonzero value, this is equivalent to having a conic constant k with a non-zero value. Accordingly, an equivalent surface may be described by specifying a conic constant k that is non zero, a coefficient a₁ that is non-zero, or a combination of a nonzero k and a non-zero coefficient a₁. Further, in some embodiments, the at least one aspheric surface is described or defined by at least one higher order aspheric coefficients a₂−a₁₂ with non-zero value (i.e., at least one of a₂, a₃ . . . a₁₂≠0). In one example embodiment, the aspheric optical element 120 comprises a third-order aspheric optical element such as a cubically shaped optical element, which comprises a coefficient a₃ that is non-zero.

In some embodiments, when the aspheric optical element 120 comprises an axicon 122 (as depicted in FIG. 3), the axicon 122 may have a laser output surface 126 (e.g., conical surface) having an angle of about 1.2°, such as from about 0.5° to about 5°, or from about 1° to about 1.5°, or even from about 0.5° to about 20°, the angle measured relative to the laser input surface 124 (e.g., flat surface) upon which the pulsed laser beam 112 enters the axicon 122. Further, the laser output surface 126 terminates at a conical tip. Moreover, the aspheric optical element 120 includes a centerline axis 125 extending from the laser input surface 124 to the laser output surface 126 and terminating at the conical tip. In other embodiments, the aspheric optical element 120 may comprise a waxicon, a spatial phase modulator such as a spatial light modulator, or a diffractive optical grating. In operation, the aspheric optical element 120 shapes the incoming pulsed laser beam 112 (e.g., an incoming Gaussian beam) into a quasi-non-diffracting beam, which, in turn, is directed through the first lens 130 and the second lens 132.

Referring still to FIG. 3, the first lens 130 is positioned upstream the second lens 132 and may collimate the pulsed laser beam 112 within a collimation space 134 between the first lens 130 and the second lens 132. Further, the second lens 132 may focus the pulsed laser beam 112 into the transparent workpiece 160, which may be positioned at an imaging plane 104. In some embodiments, the first lens 130 and the second lens 132 each comprise plano-convex lenses. When the first lens 130 and the second lens 132 each comprise plano-convex lenses, the curvature of the first lens 130 and the second lens 132 may each be oriented toward the collimation space 134. In other embodiments, the first lens 130 may comprise other collimating lenses and the second lens 132 may comprise a meniscus lens, an asphere, or another higher-order corrected focusing lens.

Referring again to FIGS. 1A-3, a method for forming the closed contour line 170 comprising defects 172 along the closed contour 165 includes directing (e.g., localizing) a pulsed laser beam 112 oriented along the beam pathway 111 and output by the beam source 110 into the transparent workpiece 160 such that the portion of the pulsed laser beam 112 directed into the transparent workpiece 160 generates an induced absorption within the transparent workpiece and the induced absorption produces a defect 172 within the transparent workpiece 160. For example, the pulsed laser beam 112 may comprise a pulse energy and a pulse duration sufficient to exceed a damage threshold of the transparent workpiece 160. In some embodiments, directing the pulsed laser beam 112 into the transparent workpiece 160 comprises focusing the pulsed laser beam 112 output by the beam source 110 into the pulsed laser beam focal line 113 oriented along the beam propagation direction (e.g., the Z axis). The transparent workpiece 160 is positioned in the beam pathway 111 to at least partially overlap the pulsed laser beam focal line 113 of pulsed laser beam 112. The pulsed laser beam focal line 113 is thus directed into the transparent workpiece 160. The pulsed laser beam 112, e.g., the pulsed laser beam focal line 113 generates induced absorption within the transparent workpiece 160 to create the defect 172 in the transparent workpiece 160. In some embodiments, individual defects 172 may be created at rates of several hundred kilohertz (i.e., several hundred thousand defects per second).

In some embodiments, the aspheric optical element 120 may focus the pulsed laser beam 112 into the pulsed laser beam focal line 113. In operation, the position of the pulsed laser beam focal line 113 may be controlled by suitably positioning and/or aligning the pulsed laser beam 112 relative to the transparent workpiece 160 as well as by suitably selecting the parameters of the optical assembly 100. For example, the position of the pulsed laser beam focal line 113 may be controlled along the Z-axis and about the Z-axis. Further, the pulsed laser beam focal line 113 may have a length in a range of from about 0.1 mm to about 100 mm or in a range of from about 0.1 mm to about 10 mm. Various embodiments may be configured to have a pulsed laser beam focal line 113 with a length l of about 0.1 mm, about 0.2 mm, about 0.3 mm, about 0.4 mm, about 0.5 mm, about 0.7 mm, about 1 mm, about 2 mm, about 3 mm, about 4 mm, or about 5 mm e.g., from about 0.5 mm to about 5 mm.

Referring still to FIGS. 1A-3, the method for forming the closed contour line 170 comprising defects 172 along the closed contour 165 may include translating the transparent workpiece 160 relative to the pulsed laser beam 112 (or the pulsed laser beam 112 may be translated relative to the transparent workpiece 160, for example, in the translation direction 101 depicted in FIGS. 1A and 2) to form closed contour lines 170 along the closed contour 165 to trace out the desired perimeter of the aperture 180 that may be formed in the transparent workpiece 160 after a subsequent chemical etching step. The defects 172 that may penetrate the full depth of the glass. It should be understood that while sometimes described as “holes” or “hole-like,” the defects 172 disclosed herein may generally not be void spaces, but are rather portions of the transparent workpiece 160 which has been modified by laser processing as described herein.

In some embodiments, the defects 172 may generally be spaced apart from one another by a distance along the closed contour line 170 of from about 0.1 μm to about 500 μm, for example, about 1 μm to about 200 μm, about 2 μm to about 100 μm, about 5 μm to about 20 μm, or the like. For example, suitable spacing between the defects 172 may be from about 0.1 μm to about 50 μm, such as from about 5 μm to about 15 μm, from about 5 μm to about 12 μm, from about 7 μm to about 15 μm, or from about 7 μm to about 12 μm for the TFT/display glass compositions. In some embodiments, a spacing between adjacent defects 172 may be about 50 μm or less, 45 μm or less, 40 μm or less, 35 μm or less, 30 μm or less, 25 μm or less, 20 μm or less, 15 μm or less, 10 μm or less, 5 μm or less or the like. Further, the translation of the transparent workpiece 160 relative to the pulsed laser beam 112 may be performed by moving the transparent workpiece 160 and/or the beam source 110 using one or more translation stages 190.

Beyond the perforation of a single transparent workpiece 160, the process may also be used to perforate stacks of transparent workpieces 160, such as stacks of sheets of glass, and may fully perforate glass stacks of up to a few mm total height with a single laser pass. A single glass stack may be comprised of various glass types within the stack, for example one or more layers of soda-lime glass layered with one or more layers of Corning code 2318 glass. The glass stacks additionally may have air gaps in various locations. According to another embodiment, ductile layers such as adhesives may be disposed between the glass stacks. However, the pulsed laser process described herein will still, in a single pass, fully perforate both the upper and lower glass layers of such a stack.

Referring now to FIGS. 5A-5D, following the formation of the closed contour line 170 in the transparent workpiece 160, the transparent workpiece 160 may be chemically etched to separate the transparent workpiece 160 along the closed contour line 170 to form one or more apertures 180 extending through the transparent workpiece 160. For example, the transparent workpiece 160 may be chemically etched by applying a chemical etching solution 202 comprising a chemical etchant 204 to the transparent workpiece 160, at least along the closed contour line 170. Further, when chemical etching is used to separate the transparent workpiece 160 along the closed contour line 170 to form the one or more apertures 180 extending through the transparent workpiece 160, it may be desirable to minimize the amount of material removed from the surfaces of the transparent workpiece 160 (i.e. minimizing thickness removal) and to maximize the uniformity of material removal through the depth of each defect 172. This may be achieved by minimizing the etching rate, as described in more detail below.

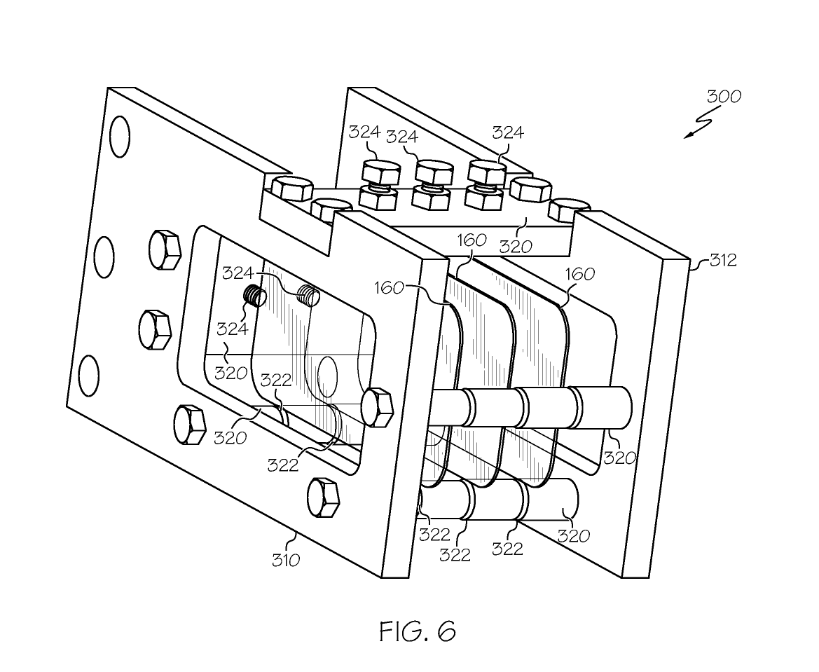

The defects 172 of the closed contour line 170 provide a pathway for the chemical etching solution 202 to penetrate into the depth of the transparent workpiece 160 and remove material of the transparent workpiece 160 within and surrounding the defects 172. For example, the chemical etching solution 202 may remove material of the transparent workpiece 160 between adjacent defects 172 along the closed contour line 170, thereby separating the material of the transparent workpiece 160 within the closed contour line 170 from the rest of the transparent workpiece 160 to form the aperture 180. Moreover, because the chemical etching solution 202 may penetrate the thickness of the transparent workpiece 160 via the defects 172, minimal transparent workpiece material must be removed to separate the transparent workpiece 160 along the closed contour line 170. Thus, the amount of time the transparent workpiece 160 is exposed to the chemical etching solution 202 may be minimized, eliminating the need for a mask to be applied to the transparent workpiece 160 during chemical etching. While a single transparent workpiece 160 is depicted submerged in the chemical etching solution 202 in FIG. 5B, it should be understood that multiple transparent workpieces 160 may be simultaneously chemically etched, for example, in a batch process, which may utilize a workpiece fixture 300, as depicted in FIG. 6.

While not intending to be limited by theory, chemically etching the defects 172 of the closed contour line 170 causes the defects 172 to form an hourglass shaped profile in which a diameter of the defect 172 at the major surfaces of the transparent workpiece 160 is greater than a waist diameter within the depth of the defect, (e.g., about halfway between each major surface of the transparent workpiece 160). As used herein, “major surfaces” refers to the imaging surface 162 of the transparent workpiece 160 and the surface opposite the imaging surface 162 (e.g., the back surface). This hourglass shaped profile is caused by the initial restriction of the chemical etching solution 202 traversing the depth of the defect 172 (i.e., diffusing through the depth of the defect 172). Thus, the portions of the defects 172 at and near the major surfaces will immediately undergo etching when the chemical etching solution 202 contacts the transparent workpiece 160; while portions of the defect 172 within the transparent workpiece 160 will not undergo etching until the chemical etching solution 202 diffuses through the depth of the defects 172 (i.e., diffuses from each major surface to the waist of the defect 172).

Accordingly, during chemical etching, the diameter of the defect 172 at the major surfaces may be larger than the waist diameter of the defect 172. Further, once the chemical etching solution 202 traverses the defect 172 (i.e. reaches the waist/center of the defect 172), the difference between the surface diameters and the waist diameter of each defect 172 will remain constant thereafter. Thus, minimizing the etching rate will minimize the thickness loss of material of the transparent workpiece 160 and the minimize the difference between the surface diameter and the waist diameter of the defects 172 because minimizing the etching rate minimizes the amount of material of the transparent workpiece 160 removed before the chemical etching solution 202 extends through the depth of the transparent workpiece 160. In other words, minimizing the etching rate will maximize the uniformity of material removal through the depth of each defect 172 such that the difference between the diameter of the defect 172 at the major surfaces and the waist diameter of the defect 172 is minimized. Moreover, increasing the uniformity of the defect 172 results in more uniform walls of the aperture 180 formed by release of the closed contour line 170 (i.e. aperture walls that are nearly or fully orthogonal to the major surfaces of the transparent workpiece 160)

While not intending to be limited by theory, the etching rate is a controllable variable of the Thiele modulus (φ) of a chemical etching process, which mathematically represents a ratio of etching rate to diffusion rate, as described in Thiele, E. W. Relation between catalytic activity and size of particle, Industrial and Engineering Chemistry, 31 (1939), pp. 916-920. While not intending to be limited by theory, when the etching rate is greater than the diffusion time, the Thiele modulus will be greater than 1. This means that the initial chemical etching solution 202 introduced into the defect 172 will be depleted before it reaches the waist (e.g., center) of the defect 172 where it can be replenished by diffusion of additional chemical etchant from the portion of the defect 172 at the opposite surface of the transparent workpiece 160. As a result, chemical etching will begin earlier at the top and bottom of the defects 172 than at the center (e.g., waist), leading to an hourglass-like shape formed from the defect 172. However, if the diffusion time is equal to or greater than the etching rate, then the Thiele modulus will be less than or equal to 1. Under such conditions, the chemical etchant concentration will be uniform along the entire defect 172 and the defect 172 will be etched uniformly, yielding a substantially cylindrical void along each defect 172 and minimizing material removal required to release the transparent workpiece 160 along the closed contour line 170 because the voids formed by the chemical etching solution 202 at the defects 172 will join adjacent voids substantially simultaneously along the entire depth of the defects 172, limiting or eliminating removal of excess material at the top and bottom portions of the defects 172. Such voids could be characterized by having a ratio of top diameter to waist diameter of about 1:0.9 to about 1:0.99.

As described herein, the etching rate can be controlled to control the Thiele modulus of the chemical etching process, and thereby control the ratio of the expansion of the waist diameter of the void formed along the defect 172 to ratio of expansion of the diameters of the top and bottom openings of the void formed from the defect 172. Further, in some embodiments, the Thiele modulus for the chemical etching process described herein can be less than or equal to about 5, less than or equal to about 4.5, less than or equal to about 4, less than or equal to about 3.5, less than or equal to about 3, less than or equal to about 2.5, less than or equal to about 2, less than or equal to about 1.5, or less than or equal to about 1.

Referring still to FIGS. 5A-5D, in some embodiments, the chemical etching solution 202 may remove material from the transparent workpiece 160 at an etching rate of from about 0.01 μm per minute (μm/min) to about 10 μm/min, for example, 0.05 μm/min, 0.1 μm/min, 0.2 μm/min, 0.3 μm/min, 0.4 μm/min, 0.5 μm/min, 0.6 μm/min, 0.7 μm/min, 0.8 μm/min, 0.9 μm/min, 1 μm/min, 1.1 μm/min, 1.2 μm/min, 1.3 μm/min, 1.4 μm/min, 1.3 μm/min, 1.4 μm/min, 1.5 μm/min, 1.6 μm/min, 1.7 μm/min, 1.8 μm/min, 1.9 μm/min, 2 μm/min, 2.1 μm/min, 2.2 μm/min, 2.3 μm/min, 2.4 μm/min, 2.5 μm/min, 2.6 μm/min, 2.7 μm/min, 2.8 μm/min, 2.9 μm/min, 3 μm/min, 3.5 μm/min, 4 μm/min, 4.5 μm/min, 5 μm/min, 5.5 μm/min, 5.5 μm/min, 6 μm/min, 6.5 μm/min, 7 μm/min, 7.5 μm/min, 8 μm/min, 8.5 μm/min, 9 μm/min, 9.5 μm/min, 10 μm/min, or the like. For example, the etching rate may be about 5 μm/min or less, about 4 μm/min or less, about 3 μm/min or less, about 2.5 μm/min or less, about 2 μm/min or less, about 1.5 μm/min or less, about 1 μm/min or less, about 0.5 μm/min or less, about 0.25 μm/min or less, about 0.1 μm/min or less, or the like. Further, the etching rate may be from about 0.01 μm/min to about 1 μm/min, or about 0.1 μm/min to about 1 μm/min, about 0.5 μm/min to about 5 μm/min, about 1 μm/min to about 10 μm/min, 0.1 μm/min to about 5 μm/min, or the like.

When the chemical etching solution 202 is applied to the transparent workpiece 160 to release the closed contour line 170 and remove material of the transparent workpieces 160 thereby forming the apertures 180, the chemical etching solution 202 may remove from between about 10 μm to about 5 mm, or about 10 μm and about 90 μm of material from the thickness of the transparent workpiece 160, for example, from about 35 μm to about 85 μm, 50 μm to about 80 μm, 60 μm to about 80 μm, 70 μm to about 85 μm, or the like. Further, when the chemical etching solution 202 is applied to the transparent workpiece 160 to release the closed contour line 170 and remove material of the transparent workpieces 160 thereby forming the apertures 180, the chemical etching solution 202 may remove about 50% or less of a thickness of the transparent workpiece 160, about 25% or less of a thickness of the transparent workpiece 160, about 15% or less of a thickness of the transparent workpiece 160, about 10% or less of a thickness of the transparent workpiece 160, about 7.5% or less of a thickness of the transparent workpiece 160, about 5% or less of a thickness of the transparent workpiece 160, about 2.5% or less of a thickness of the transparent workpiece 160, or the like.

While not intending to be limited by theory, the etching rate may be lowered by lowering the concentration of chemical etchant 204 of the chemical etching solution 202, lowering the temperature of the chemical etching solution 202, agitating the chemical etching solution 202 during etching, for example, using ultrasonics, physical motion, or the like. Further, the etching rate may be affected by the composition of the transparent workpiece 160. While not intended to be limited by theory, increased alkali content in the transparent workpiece 160 increases the etching rate. For example, given a common chemical etching solution, etching rates for alikali aluminosilicate glass (e.g., Corning Code 2320) are about 2.5 times faster than etching rates of alkaline earth boro aluminosilicate (e.g., EAGLE XG®).

Referring still to FIGS. 5A-5D, the chemical etching solution 202 may be an aqueous solution that includes the chemical etchant 204 and deionized water 208. In some embodiments, the chemical etchant 204 may comprise a primary acid and a secondary acid. The primary acid can be hydrofluoric acid and the secondary acid can be nitric acid, hydrochloric acid, or sulfuric acid. In some embodiments, the chemical etchant 204 may only include a primary acid. In some embodiments, the chemical etchant 204 may include a primary acid other than hydrofluoric acid and/or a secondary acid other than nitric acid, hydrochloric acid, or sulfuric acid. For example, in some embodiments, the primary acid chemical etchant 204 may comprise from about 1% by volume hydrofluoric acid to about 15% by volume hydrofluoric acid, for example, about 2.5% by volume hydrofluoric acid to about 10% by volume hydrofluoric acid, 2.5% by volume hydrofluoric acid to about 5% by volume hydrofluoric acid, and all ranges and subranges in between. Further, in some embodiments, the secondary acid may comprise may comprise from about 1% by volume hydrofluoric acid to about 20% by volume nitric acid, for example, about 2.5% by volume nitric acid to about 15% by volume nitric acid, 2.5% by volume nitric acid to about 10% by volume nitric acid, 2.5% by volume nitric acid to about 5% by volume nitric acid and all ranges and subranges in between. As additional examples, chemical etchants 204 can include 10% by volume hydrofluoric acid/15% by volume nitric acid, 5% by volume hydrofluoric acid/7.5% by volume nitric acid, 2.5% by volume hydrofluoric acid/3.75% by volume nitric acid, 5% by volume hydrofluoric acid/2.5% by volume nitric acid, 2.5% by volume hydrofluoric acid/5% by volume nitric acid or the like. Further, lowering the concentration of chemical etchant 204 in the chemical etching solution may lower the etching rate. Thus, it may be advantageous to use a minimum effective concentration of chemical etchant 204 in the chemical etching solution 202. In some embodiments, the chemical etchant 204 may comprise a base, such as sodium hydroxide or potassium hydroxide. As an example, the chemical etchant 204 may comprise about 5M sodium hydroxide to about 20M sodium hydroxide. As an additional example, the chemical etchant 204 may comprise about 5M potassium hydroxide to about 20M potassium hydroxide.

In operation, the etching time required to separate the portion of the transparent workpiece 160 surrounded by the closed contour line 170 from the remaining transparent workpiece 160, thereby forming the aperture 180 in the transparent workpiece 160 may be from about 2 mins to 1,000 mins or greater, for example, 5 mins to about 40 mins, 5 mins to about 30 mins, 5 mins to about 20 mins, 10 mins to about 30 mins, 10 mins to about 20 mins, 15 mins to about 30 mins, 20 mins to 60 mins, 60 mins to 200 mins, 100 mins to 1,000 mins, greater than 1,000 mins or the like. The temperature of the chemical etching solution 202 when etching the transparent workpiece 160 may be from about 0° C. to about 40° C., for example, about 30° C. or less, about 20° C. or less about 10° C. or less, about 5° C. or less, or the like. For example, about 2° C., 5° C., 7° C., 10° C., 12° C., 15° C., 18° C., 20° C., 25° C., 30° C., 35° C., or the like. Further, lowering the temperature of the chemical etching solution 202 when etching the transparent workpiece 160 lowers the etching rate. Thus, colder etching temperatures may be advantageous. In the example of a chemical etching solution 202 that comprises a basic etching solution, the temperature of the chemical etching solution 202 when etching the transparent workpiece 10 may be from about 70° C. to about 100° C.

As depicted in FIG. 5B, the chemical etching solution 202 may be housed in a chemical etching bath 200, which may include from about 5 L to about 15 L of the chemical etching solution 202, for example, about 8 L to about 10 L. In some embodiments, a larger chemical etching bath 200 and a larger volume of chemical etching solution 202 may be desired to allow more space for motion and agitation. In some embodiments, the chemical etching solution 202 may further comprise a surfactant 206 (FIG. 5D), which increases the wettability of the defects 172 when applied to the transparent workpiece 160. The increased wettability lowers the diffusion time of the chemical etching solution 202 through the depth of each defect 172, which may be desirable as described below. In some embodiments, the surfactant 206 can be any suitable surfactant that dissolves into the chemical etching solution 202 and that does not react with the chemical etchant 204 in the chemical etching solution 202. In some embodiments, the surfactant 206 can be a fluorosurfactant such as Capstone® FS-50 or Capstone® FS-54. In some embodiments, the concentration of the surfactant 206 in terms of ml of surfactant/L of etching solution can be about 1, about 1.1, about 1.2, about 1.3, about 1.4, about 1.5, about 1.6, about 1.7, about 1.8, about 1.9, about 2 or greater.

In operation, the transparent workpiece 160 comprising the closed contour line 170 (or multiple closed contour lines 170 corresponding with multiple desired apertures 180) may be immersed in a chemical etching bath 200 comprising the chemical etching solution 202, as depicted in FIG. 5B. Further, while the chemical etching solution 202 is primarily described herein as an aqueous solution, in some embodiments, the chemical etching solution 202 may comprise a gaseous solution comprising, for example, a vapor HF chemical etchant. In operation, the gaseous chemical etching solution may be applied to the transparent workpiece 160 using a spray etching process. Using a gaseous chemical etching solution may remove the need for an agitation process in order to etch into the depth of the transparent workpiece 160 along the defects 172, as gas may more readily diffuse into the defects 172 than liquid. Voids created through such a method could be characterized by having a ratio of top diameter to waist diameter of about less than 1:0.9 to about 1:1.

While not intending to be limited by theory, forming the closed contour line 170 comprising the plurality of defects 172 is a zero or near zero kerf process and thus, when the closed contour line 170 is formed in the transparent workpiece 160, it is difficult to separate the material of the transparent workpiece 160 within the closed contour line 170 from the rest of the transparent workpiece 160 without damaging the transparent workpiece 160. However, chemically etching the transparent workpiece 160 after forming the closed contour line 170 enlarges the defects 172 of the closed contour line 170 to release the closed contour line 170 and create one or more apertures 180 without unintended damage to the transparent workpiece 160.

In some embodiments, the chemical etching solution 202 may be agitated when the transparent workpiece 160 is positioned within the chemical etching bath 200. For example, the chemical etching solution 202 may be mechanically agitated, ultrasonically agitated, or combinations thereof. Additionally, the chemical etching solution 202 may be agitated by recirculation of the chemical etching solution 202. Agitation may increase the diffusion rate of the chemical etching solution 202 through the depth of the defects 172, thereby facilitating faster separation while limiting material removal and facilitating uniformly shaped defects 172 (any thereby uniformly shaped aperture walls). In some embodiments, the chemical etching bath 200 may be mechanically agitated in the X, Y, and Z directions to improve uniform etching of the defects 172. The mechanical agitation in the X, Y, and Z directions may be continuous or variable. In some embodiments, the chemical etching bath 200 may comprise one or more ultrasonic transducers configured to generate ultrasonic agitation of the chemical etching solution 202 within the chemical etching bath 200. For example, the ultrasonic transducers may be located at the bottom of the chemical etching bath 200 or one or more sides of the chemical etching bath 200. Ultrasonic transducers may generate frequencies such as 40 kHz, 58 kHz, 80 kHz, 120 kHz, 132 kHz, and 192 kHz or a combination thereof.

Further, during ultrasonic agitation, the transparent workpiece 160 may be oriented within the chemical etching bath 200 such that the both ends of each defect 172 (e.g., the portions of the defect 172 located at the imaging surface 162 and the surface opposite the imaging surface 162) receive substantially uniform exposure to ultrasonic waves such that the defects 172 of the closed contour line 170 are etched uniformly. For example, if the ultrasonic transducers are arranged at the bottom of the chemical etching bath 200, the transparent workpiece 160 can be oriented in the chemical etching bath 200 so that the surfaces of the transparent workpiece 160 between which the defects 172 are perpendicular to the bottom of the chemical etching bath 200 (e.g., face the sides of the chemical etching bath 200) rather than parallel to the bottom of the chemical etching bath 200.

Referring now to FIG. 6, the one or more transparent workpieces 160 may be held in the chemical etching bath 200 using the workpiece fixture 300. The workpiece fixture 300 may be configured to hold the transparent workpiece 160 with minimal contact, as contact between the workpiece fixture 300 and the transparent workpiece 160 may create marks or impressions (e.g., optical blemishes) on the transparent workpiece 160 because contact between the workpiece fixture 300 and the transparent workpiece 160 may prevent or impede flow of the chemical etching solution 202 to the portions of a surface of the transparent workpiece 160 that contact the workpiece fixture 300. These optical blemishes are subtle but may be visible in reflected light due to a mismatch in material removal at discrete locations of the transparent workpiece 160 (i.e. differential local etching). While not intending to be limited by theory, optical blemishes are caused due to differing fluid flow rates and fluid contact times between the chemical etching solution 202 and different portions of the transparent workpiece 160 causing deviations in the etching rate at these different portions of the transparent workpiece 160 (i.e. differential local etching). Further, optical blemishes may diminish the visual quality of the transparent workpiece 160. As described below, the workpiece fixture 300 is configured to minimize optical blemishes by minimizing contact between the workpiece fixture 300 and the transparent workpiece 160 during the etching process, minimizing the formation of etchant byproducts, and minimizing contact between portions of the transparent workpiece 160 that are disconnected from the remainder of the transparent workpiece 160.

As depicted in FIG. 6, the workpiece fixture 300 comprises a first fixture wall 310, a second fixture wall 312 and a plurality of fixture cross-bars 320 coupled to and extending between the first fixture wall 310 and the second fixture wall 312. Further, the fixture cross-bars 320 may comprise one or more grooves 322, one or more set screws 324, or a combination thereof. For example, in the embodiment depicted in FIG. 6, the workpiece fixture 300 comprises five fixture cross-bars 320, two comprising a plurality of set screws 324 and three comprising a plurality of grooves 322. It should be understood that other arrangements of grooves 322 and set screws 324 are contemplated. In operation, one or more transparent workpieces 160 may be disposed within the coplanar grooves 322 of the fixture cross-bars 320 and fixed in position by engagement with corresponding coplanar set screws 324 of the fixture cross-bars 320. The plurality of grooves 322 may have a depth of from about 50 μm to about 500 μm, for example, about 75 μm, 100 μm, 125 μm, 150 μm, 175 μm, 200 μm, 225 μm, 250 μm, 275 μm, 300 μm, 325 μm, 350 μm, 375 μm, 400 μm, 425 μm, 450 μm, 475 μm, or the like.

Each of the plurality of grooves 322 may be V-shaped to minimize contact between the transparent workpiece 160 and each groove 322. The set screws 324 may also have V-shaped grooves on a contact face of the set screws 324 to minimize contact between the transparent workpiece 160 and the set screws 324. Further, the set screws 324 may be tightened such that the transparent workpiece 160 sits within the grooves of the set screws 324 without firm contact to minimize marking effects. In some embodiments, the transparent workpiece 160 is held by multiple V-shaped grooves 322 to allow the transparent workpiece 160 to jostle within the grooves 322, minimizing the formation of marks and impressions in the transparent workpiece 160. In some embodiments, the workpiece fixture 300 may comprise Teflon™ or other polymers such as thermopolymers, fluoropolymers, or the like. Further, after chemically etching, the transparent workpiece 160 may undergo a post-etch finishing process, for example, grinding and/or polishing the transparent workpiece 160 to remove any marks or impressions formed on the transparent workpiece 160 by the workpiece fixture 300.

Further, a low etching rate may reduce the formation of optical blemishes. While not intending to be limited by theory, increasing the etching rate increases the rate of formation of insoluble byproducts of the etching process, which may mask portions of the transparent workpiece 160 and cause differential local etching, forming optical blemishes that are visible as streaks on the transparent workpiece. In contrast, lowering the etching rate lowers the rate of formation of insoluble byproducts, allowing the agitation of the chemical etching solution 202 and/or the transparent workpiece 160 to remove the insoluble byproducts from contact with the transparent workpiece 160, reducing the differential local etching caused by these byproducts. Even without agitation, the lowering the rate of formation of insoluble byproducts means a larger portion of the insoluble byproducts will diffuse away from the transparent workpiece 160 before causing the formation of optical blemishes.

Moreover, optical blemishes formed on the transparent workpiece 160 by contact between the transparent workpiece 160 and the workpiece fixture 300 may be minimized by rotating the transparent workpiece 160 when the transparent workpiece 160 is disposed (e.g., immersed) in the chemical etching bath 200. While not intending to be limited by theory, directional optical blemishes are caused by gravity pulling chemical etchant byproducts over a surface of the transparent workpiece 160. However, rotating the transparent workpiece 160 disperses optical blemishes in multiple directions, such that chemical etchant byproducts are dispersed over the surface of the transparent workpiece 160 in multiple directions and in any one direction for a reduced period of time, forming optical blemishes that are dispersed and less visually noticeable.

Optical blemishes may also be formed when a portion of the transparent workpiece 160 (e.g., a portion within the closed contour 170) that is no longer connected to the remainder of the transparent workpiece 160 adheres to the transparent workpiece 160, for example, when this “disconnected” portion of the transparent workpiece 160 is not yet removed to form the aperture 180. In this situation, the portion of the transparent workpiece 160 that is covered by this disconnected portion receives differential local etching, resulting in optical blemishes. Thus, removing these disconnected portions, for example, using agitation, rotation, or the like may reduce optical blemishes.

Further, the diameter (or other cross-sectional size) of the aperture 180 is larger than the diameter (or other cross-sectional size) of the corresponding closed contour 170 used to form the aperture 180, due to the removal of material caused by chemical etching. Thus, the size of the closed contour 170 should account for this difference to form apertures 180 with a desired size. Moreover, etching rates can vary spatially. For example, a 400 μm diameter closed contour 170 will etch differently than a 6 mm diameter closed contour 170, even if the same laser parameters are used. Thus, to obtain a precisely size aperture 180 after chemical etching, a comprehensive size and contour dependent experiment may be executed.

In some embodiments, multiple transparent workpieces 160 may be simultaneously etched, for example, by simultaneous immersion in a chemical etching bath 200. However, these multiple transparent workpieces 160 should be oriented and spaced to limit the degree of ultrasonic agitation blocked by the multiple transparent workpieces 160. In other words, the multiple transparent workpieces 160 should be oriented and spaced to maximize the number or transparent workpieces 160 etched at once while retaining desirable levels of agitation.

Referring now to FIG. 7, an exploded view an electronic device 10 that includes a transparent workpiece 160 as a cover glass plate is depicted. The transparent workpiece 160 of FIG. 7 comprises the plurality of apertures 180 formed using the above described processes and the electronic device 10 comprises one or more speakers 12 aligned with the plurality of apertures 180, which provide acoustic pathways through the transparent workpiece 160. Further, each aperture 180 comprises an aperture perimeter 182, which is located at the previous location of individual closed contour lines 170. In some embodiments, each aperture 180 may comprise a cross-sectional dimension (e.g., diameter) of from about 100 μm to about 10 mm, for example, 5 mm or less, 3 mm or less, 1 mm or less, 900 μm, 800 μm or less, 700 μm, 600 μm or less, 500 μm or less, 400 μm, 300 μm or less, 250 μm or less, 200 μm or less, 100 μm or less, or the like. In some embodiments, the transparent workpiece 160 may comprise arrays of apertures 180 with individual apertures 180 having varying diameter.

In embodiments in which the transparent workpiece 160 comprising the array of apertures 180 comprises non-strengthened glass, edges of each aperture 180 along the aperture perimeter 182 may comprise an edge strength of from about 200 MPa to about 500 MPa, for example 250 MPa, 300 MPa, 350 MPa, 400 MPa, 450 MPa, or the like. Further, in embodiments in which the transparent workpiece 160 comprising the array of apertures 180 comprises strengthened glass, for example, ion-exchanged glass, edges of each aperture 180 along the aperture perimeter 182 may comprise an edge strength of from about 600 MPa to about 1000 MPa, for example 650 MPa, 700 MPa, 750 MPa, 800 MPa, 850 MPa, 900 MPa, 950 MPa, or the like. Further, the array of apertures 180 may reduce the strength of the transparent workpiece 160 (when compared to a similar transparent workpiece without apertures) by 30% or less, 20% or less, 10% or less, or the like.

In some embodiments, for example, embodiments in which the apertures 180 provide acoustic pathways, the one or more of the apertures 180 may extend through the transparent workpiece 160 at an angle such that each aperture 180 is not perpendicular to the surfaces of the transparent workpiece 160 that the aperture 180 extends between. For example, angular defects may be formed by directing the pulsed laser beam focal line 113 (FIGS. 1A and 1B) through the transparent workpiece 160 at an angle not perpendicular to the imaging surface 162 of the transparent workpiece 160 to form a closed contour line 170 comprising angular defects. These angular defects may be chemically etched to form angular apertures.

Moreover, while the apertures 180 are described herein as acoustic pathways, it should be understood that the processes described herein may be used to form any apertures in a transparent workpiece 160, for example, slots, home buttons, or the like. For example, in some embodiments, the transparent workpiece 160 may be used as a backplate for a computer keyboard and the apertures 180 may serve as key holes that allow each key of the keyboard to extend through an individual aperture 180. These apertures 180 may be comprise different cross-sectional sizes to accommodate keyboard keys having a variety of sizes.

In view of the foregoing description, it should be understood that formation of a closed contour line comprising defects along a closed contour corresponding with a desired aperture perimeter may be enhanced by utilizing a pulsed laser beam which is shaped by an optical assembly into a pulsed laser beam focal line such that the pulsed laser beam focal line irradiates the transparent workpiece along the closed contour. Further, it should be understood that the closed contour line comprising defects may be separated from the rest of the transparent workpiece by chemically etching the transparent workpiece to form apertures extending through the transparent workpiece. Moreover, these apertures may be used as acoustic pathways when the transparent workpiece is a cover plate of an electronics device.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method for processing a transparent workpiece, the method comprising:
forming a closed contour line in the transparent workpiece, the closed contour line comprising a plurality of defects in the transparent workpiece such that the closed contour line defines a closed contour, wherein forming the closed contour line comprises:
directing a pulsed laser beam oriented along a beam pathway and output by a beam source through an aspheric optical element and into the transparent workpiece such that a portion of the pulsed laser beam directed into the transparent workpiece generates an induced absorption within the transparent workpiece, the induced absorption producing a defect within the transparent workpiece, and the portion of the pulsed laser beam directed into the transparent workpiece comprises:
a wavelength λ;
a spot size wₒ; and
a cross section that comprises a Rayleigh range Z_{R} that is greater than
$${F}_{D} \frac{π {w}_{0 ,}^{2}}{λ} ,$$
where F_{D} is a dimensionless divergence factor comprising a value of 10 or greater; and
translating the transparent workpiece and the pulsed laser beam relative to each other along the closed contour line, thereby laser forming the plurality of defects along the closed contour line within the transparent workpiece; and
etching the transparent workpiece with a chemical etching solution at an etching rate of about 10 μm/min or less to separate a portion of the transparent workpiece along the closed contour line, thereby forming an aperture extending through the transparent workpiece, the aperture comprising an aperture perimeter extending along the closed contour.

2. The method of claim 1, wherein the etching rate is about 5 μm/min or less.

3. The method of claim 1, wherein the etching rate is about 2.5 μm/min or less.

4. The method of claim 1, wherein etching the transparent workpiece removes about 15% or less of a thickness of the transparent workpiece.

5. The method of claim 1, wherein etching the transparent workpiece removes about 7.5% or less of a thickness of the transparent workpiece.

6. The method of claim 1, wherein a spacing between adjacent defects is about 25 μm or less.

7. The method of claim 1, wherein the aperture perimeter comprises a diameter of about 800 μm or less.

8. The method of claim 1, wherein:
the chemical etching solution comprises a chemical etchant and deionized water; and
the chemical etchant of the chemical etching solution comprises hydrofluoric acid, nitric acid, hydrochloric acid, sulfuric acid, or combinations thereof.

9. The method of claim 1, wherein etching the transparent workpiece with the chemical etching solution comprises immersing the transparent workpiece in a chemical etching bath comprising the chemical etching solution.

10. The method of claim 9, wherein:
the transparent workpiece is immersed in the chemical etching bath for an etching time of from about 15 mins to about 30 mins; and
the temperature of the chemical etching solution when the transparent workpiece is immersed in the chemical etching bath is about 20° C. or less.

11. The method of any of claim 1, wherein etching the transparent workpiece with the chemical etching solution further comprises agitating the chemical etching solution when the transparent workpiece is immersed in the chemical etching bath.

12. The method of claim 1, further comprising coupling the transparent workpiece to a workpiece fixture and immersing the transparent workpiece and the workpiece fixture in a chemical etching bath, wherein the workpiece fixture comprises a first fixture wall, a second fixture wall, and a plurality of fixture cross-bars coupled to and extending between the first fixture wall and the second fixture wall, wherein one or more grooves extend into at least one of the plurality of fixture cross-bars.

13. The method of claim 1, wherein the dimensionless divergence factor F_{D} comprises a value of from about 10 to about 2000.

14. The method of claim 1, wherein the pulsed laser beam has a wavelength λ and wherein the transparent workpiece has combined losses due to linear absorption and scattering less than 20%/mm in the beam propagation direction.

15. The method of claim 1, wherein the beam source comprises a pulsed beam source that produces pulse bursts with from about 2 sub-pulses per pulse burst to about 30 sub-pulses per pulse burst and a pulse burst energy is from about 100 μJ to about 600 μJ per pulse burst.

16. A method for processing a transparent workpiece, the method comprising:
forming a plurality of closed contour lines in the transparent workpiece, each closed contour line comprising a plurality of defects in the transparent workpiece such that each closed contour line defines a closed contour, wherein forming each closed contour line comprises:
directing a pulsed laser beam oriented along a beam pathway and output by a beam source through an aspheric optical element and into the transparent workpiece such that a portion of the pulsed laser beam directed into the transparent workpiece generates an induced absorption within the transparent workpiece, the induced absorption producing a defect within the transparent workpiece, and the portion of the pulsed laser beam directed into the transparent workpiece comprises:
a wavelength λ;
a spot size wₒ; and
a cross section that comprises a Rayleigh range Z_{R} that is greater than
$${F}_{D} \frac{π {w}_{0 ,}^{2}}{λ} ,$$
where F_{D} is a dimensionless divergence factor comprising a value of 10 or greater; and
translating the transparent workpiece and the pulsed laser beam relative to each other along the closed contour line, thereby laser forming the plurality of defects along the closed contour line within the transparent workpiece; and
etching the transparent workpiece with a chemical etching solution at an etching rate of about 10 μm/min or less to separate portions of the transparent workpiece along each closed contour line, thereby forming a plurality of apertures extending through the transparent workpiece, each aperture comprising an aperture perimeter extending along the closed contour, wherein the plurality of apertures are positioned such that when the transparent workpiece is coupled to an electronic device comprising one or more speakers, the plurality of apertures are aligned with the one or more speakers, thereby providing acoustic pathways through the transparent workpiece.

17. The method of claim 16, wherein the etching rate is about 5 μm/min or less.

18. The method of claim 16, wherein the etching rate is about 2.5 μm/min or less.

19. The method of claim 16, wherein etching the transparent workpiece removes about 50% or less of a thickness of the transparent workpiece.

20. The method of claim 16, wherein etching the transparent workpiece removes about 25% or less of a thickness of the transparent workpiece.
